(19) United States
(12) Patent Application Publication
(10) Pub. No.: US 2008/0260119 A1
(43) Pub. Date: Oct. 23, 2008

(54) SYSTEMS, METHODS, AND COMPUTER PROGRAM PRODUCTS FOR PROVIDING SERVICE INTERACTION AND MEDIATION IN A COMMUNICATIONS NETWORK

(76) Inventors: Rohini Marathe, Cary, NC (US); Venkataramalah Ravishankar, Cary, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/106,807

(22) Filed: Apr. 21, 2008

Related U.S. Application Data
(60) Provisional application No. 60/925,612, filed on Apr. 20, 2007.
(60) Provisional application No. 60/991,260, filed on Nov. 30, 2007.
(60) Provisional application No. 60/992,384, filed on Dec. 5, 2007.

(51) Int. Cl. H04M 11/00

(52) U.S. Cl. 379/93.01

(57) ABSTRACT

Systems, methods, and computer program products for providing service interaction and mediation in a communications network are disclosed. According to one aspect, the subject matter described herein includes a system for providing service interaction and mediation in a communications network. The system includes a communications interface for receiving a client-to-SCIM message from a service client; and a service capability interaction manager (SCIM) module for providing service interaction between the service client and multiple application servers providing different types of services. Providing the service interaction includes receiving, from the communications interface, the client-to-SCIM service interaction message, and, in response to receiving the client-to-SCIM message, generating multiple SCIM-to-server messages and sending the SCIM-to-server messages to multiple application servers. Providing the service interaction also includes receiving multiple server-to-SCIM service interaction messages from at least some of the application servers that received the SCIM-to-server messages, and, in response to receiving the server-to-SCIM messages, generating a SCIM-to-client message containing an aggregation of at least a portion of data from at least some of the server-to-SCIM messages, and sending the SCIM-to-client message containing the aggregation to the service client via the communications interface.

### PRIORITY CLAIM

The application claims the benefit of U.S. Provisional Patent Application Ser. No. 60/925,612, filed Apr. 20, 2007, U.S. Provisional Patent Application Ser. No. 60/991,260, filed Nov. 30, 2007, and U.S. Provisional Patent Application Ser. No. 60/992,384, filed Dec. 5, 2007; the disclosures of which are incorporated herein by reference in their entireties.

### TECHNICAL FIELD

The subject matter described herein relates to providing services in mixed-protocol telecommunications networks. More particularly, the subject matter described herein relates to systems, methods, and computer program products for providing service interaction and mediation in a communications network.

### BACKGROUND

Service interaction in a communications network refers to the process of managing the interaction between network entities that request network services, referred to as service clients, and network entities that provide those network services, referred to as application servers. Service clients may request a service from an application server by issuing messages commonly referred to as service requests, service trigger messages, or service queries. Application servers may respond to such requests by issuing messages commonly referred to as service request responses, service responses, or simply responses.

Service mediation in a communications network refers to conversion of service-related messages from one message protocol into another message protocol. Service mediation may also entail determining whether a requesting client or communications service subscriber is authorized to access network applications/services, and subsequently enforcing such access authorization rules. Service mediation becomes necessary as formerly distinct networks are merged, requiring network elements to communicate in each other's protocol, and as protocols themselves are improved and modified to the point that newer versions of a protocol are no longer backwards-compatible with older versions of the same protocol.

One example of networks that are created from the merger of previously distinct and often incompatible networks are telecommunications networks. Modern telecommunications networks may be an amalgam of land-line telephone networks, mobile telephone networks, and data networks. Each formerly separate piece of a now-consolidated network may have its own services, which the other pieces of the network would like to use.

One example service is prepaid calling, in which a subscriber purchases in advance an amount of network usage. A prepaid subscriber might purchase a certain number of minutes of call time, and once the subscriber has used all of the purchased minutes, the subscriber's access to the network may be barred unless and until more minutes are purchased. Thus, whenever a prepaid subscriber attempts to use the network, a query may be made to determine whether the subscriber's prepaid account has a balance sufficient to allow the subscriber to proceed. For example, when a prepaid subscriber tries to make a call, the subscriber connects to the telecommunications network through a mobile switching center (MSC) if the subscriber is a using a mobile phone, and through a service switching point (SSP) if the subscriber is using a land line. An MSC/SSP is hereinafter generically referred to as a switching point (SP). An SP typically queries a service control point (SCP) that maintains a prepaid database (i.e., a “prepaid SCP”) to determine whether a mobile subscriber's prepaid account balance is sufficient to allow the call to proceed.

The query to a prepaid SCP is one possible step in a sequence of steps that the cell phone, the SP, and various SCPs perform in the process of connecting to a network and setting up a call. This process may be defined by a basic call state model (BCSM) in which the process is described in terms of transitions in a call state diagram, where each call state may represent a change of status, such as “dialing”, “ringing”, “connected”, “disconnected”, etc. The SP may track and maintain the state information for each call that it processes, based on the BCSM used by the SP.

A BCSM may include some point in the state machine where control of the call may be permanently or temporarily transferred to another entity. Such a point in the state machine is called a detection point. Detection points are based on the specific call model applicable to the protocol being used by the SP. The SP may generate a service trigger message in response to a triggering event in detection point. One example of a service trigger message is an IDP message. The service trigger message typically contains parameters, such as a service key, that identify which service is being requested.

For example, in the prepaid subscriber example above, when the subscriber attempts to place a call, the subscriber's cell phone sends the called party telephone number to an SP. In an example BCSM, a detection point may when the SP successfully receives the called party number. In response to the detection point, the SP may send a service trigger message, such as an IDP message, to a prepaid SCP to query the prepaid account balance for the calling party, the called party, or both. The service trigger message may include a service key that identifies the service desired. In this example, the service desired is a query to a prepaid database. The prepaid SCP may perform a prepaid account balance query and then return control of the call to the SP along with an indication of whether or not the prepaid subscriber(s) had a sufficient account balance to allow the call to proceed. Thus, by issuing the service trigger message the SP may temporarily pass control of the call to the prepaid SCP and regain control from the prepaid SCP upon receipt of a service response message.

One problem associated with conventional telecommunications networks is one of interoperability. As telecommunications signaling networks have evolved, so too have the protocols, and a merged communications network may use protocols ranging from system signaling #7 (SS7) protocol to SIGTRAN, which can be thought of as SS7 over Internet protocol (IP), to session initiation protocol (SIP), and others. Within the SS7 protocol family, there are multiple variants, such as intelligent network (IN), advanced intelligent network (AIN), wireless intelligent network (WIN), and customized applications for mobile networks enhanced logic (CAMEL). Thus, different application servers may use different protocols. Similarly, a client requesting the services may use protocols different from the protocol used by the application server. For example, an operator may have a prepaid SCP running IN protocol, but may want to access the same prepaid SCP from a new CAMEL-based SP; or, the operator may want to offer a new service, that is only available on a SIP application server (SAS), to service clients that only support IN and CAMEL. Many other examples may be contemplated by those knowledgeable in the art. Because the individual pieces of the merged network may use separate protocols, they may not interoperate well, or at all.

One proposed solution to the problem of interoperability is to modify the service clients so that they support all protocols required by the various application servers. Another proposed solution is to modify the application servers so that they support all protocols required by the various service clients. Both proposed solutions can be very expensive, due to the number of entities on the network that may need to be modified. In addition, protocol mediation can involve more than mere message format conversion, and may require maintenance of separate data structures, state machines, and the like, adding complexity to the call state models. Furthermore, putting additional complexity into either the service clients or the application servers may potentially tie a communications network to one client or server vendor, reducing that vendor's incentive to provide flexible solutions and/or competitive pricing.

Another problem that limits interoperability of various components of a telecommunications network is that current implementations of service clients and applications servers support very limited service interaction. In particular, current implementations of MSCs and SSPs do not have the ability to generate multiple service request messages in response to a single detection point. This inability can prevent a telecommunications service provider from providing complex service packages that require interaction among multiple application servers. For example, where a prepaid subscriber wants to connect using a virtual private network (VPN), the SP may need to issue two separate service request messages, one to the prepaid SCP to determine whether the subscriber has a sufficient balance to proceed, and another to a VPN SCP to handle setting up the VPN. Thus, unless the SP can issue multiple service requests in response to a single service trigger, such as an IDP, the telecommunications service provider cannot offer a service package that allows a subscriber to be both a prepaid subscriber and a VPN subscriber.

One proposed solution to the inability to generate multiple service request messages from a single service trigger is to add this functionality to either the service client or the application server. As in the case of service mediation above, this proposed solution can be very expensive due to the number of network entities that must be upgraded, and may require that the basic call state model used by the SP, for example, to become enormously more complex, and thus harder to maintain.

Yet another proposed solution to the problem of interoperability is found in the 3^{rd} Generation Partnership Project (3GPP) specification TS 23.002, ETSI TS 123 002 V7.1.0 (2006-03). This document describes a service capability interaction manager (SCIM), which is an application which performs service interaction and mediation. The SCIM is designed to operate as an intermediary between entities that request services and entities that provide services. The SCIM is designed to appear as an application server to the service client, and as a service client to the application server. For example, a SCIM may present itself to an MSC as a CAMEL-speaking SCP, and to an SSP as an IN-speaking SCP. Similarly, the SCIM may present itself to the SCP as either an IN-speaking or CAMEL-speaking network element, depending on the capabilities of the SCP. In addition, the SCIM allows CAMEL or IN based entities that request services to communicate with IMS entities that provide services that use the SIP protocol, such as SIP Application Servers (SAS).

However, current implementations of the 3GPP SCIM do not issue multiple service requests because they are unable to process the multiple responses to the service requests and take appropriate action. The process of accepting multiple input messages (the responses to the service requests) and generating typically a single output message (a response representing the collective responses to the service requests) is referred to as “aggregation”. Since each service control network client may either accept or reject their respective requests for service, a SCIM that issues multiple requests in response to a single service trigger message must also be able to resolve conflicting responses to determine whether or not the call proceeds anyway. Current implementations of the 3GPP SCIM do not issue multiple service requests in response to a single service trigger, and do not aggregate.

Thus, a significant limitation of both conventional SPs and current implementations of the 3GPP SCIM is that, due to an inability to aggregate, they can effectively generate only a single service request message for any given service trigger, which is typically a detection point. This limits the network operator's ability to offer a “service package” to the subscriber if the service package requires multiple service requests to be issued in response to a single service trigger. For example, this limitation currently prevents a subscriber from being both a prepaid subscriber and a VPN subscriber.

Accordingly, there exists a need to manage service interactions and provide service mediation between a network entity that requests network services and a plurality of network entities that provide network services. Specifically, there exists a need for systems, methods, and computer program products for providing enhanced service interaction and mediation in a communications network.

### SUMMARY

According to one aspect, the subject matter described herein includes a system for providing service interaction and mediation in a communications network. The system includes a communications interface for receiving a client-to-SCIM message from a service client; and a service capability interaction manager (SCIM) module for providing service interaction between the service client and multiple application servers providing different types of services. Providing the service interaction includes receiving, from the communications interface, the client-to-SCIM service interaction message, and, in response to receiving the client-to-SCIM message, generating multiple SCIM-to-server messages and sending the SCIM-to-server messages to multiple application servers. Providing the service interaction also includes receiving multiple server-to-SCIM service interaction messages from at least some of the application servers that received the SCIM-to-server messages, and, in response to receiving the server-to-SCIM messages, generating a SCIM-to-client message containing an aggregation of at least a portion of data from at least some of the server-to-SCIM messages, and sending the SCIM-to-client message containing the aggregation to the service client via the communications interface.

According to another aspect, the subject matter described herein includes a system for providing rules-based service interaction and mediation in a communications network. The system includes a service interaction and mediation rules database for storing service interaction and mediation rules for providing service interaction and mediation, and a service capability interaction manager (SCIM) module for providing, using service interaction and mediation rules stored in the service interaction and mediation rules database, service interaction and mediation between a service client and a plurality of application servers providing different types of services. The service capability interaction manager module is configured to receive at least one incoming service interaction message; identify, using a component of one of the incoming messages, a service interaction and mediation rule; generate, using the identified rule, at least one outgoing service interaction message; and send the at least one outgoing message.

According to yet another aspect, the subject matter described herein includes a system for providing service interaction and mediation in a communications network. The system includes a communications interface for receiving a service interaction message including information identifying a subscriber, and a service capability interaction manager (SCIM) module for providing service interaction and mediation between a service client and a plurality of network entities. Providing the service interaction includes identifying an event, occurring at the service client and associated with the identified subscriber, for which notification is desired; identifying at least one of the plurality of network entities for receiving notification of the identified event; maintaining mappings between the identified network entities and the identified event; and sending, to the service client, a request to send notification of the identified event to the SCIM module.

According to yet another aspect, the subject matter described herein includes a service capability interaction manager (SCIM) having an extendable architecture. The SCIM includes a database for storing system configuration information and element protocol configuration information; a service interaction rules module for storing service interaction and mediation rules; a service mediation and aggregation logic module for providing service mediation and aggregation in a communications network based on stored service interaction and mediation rules and stored system configuration information; a communications interface for receiving, from a plurality of network entities, service interaction messages including information identifying a subscriber; and a plurality of protocol handlers for performing protocol mediation and conversion between a first protocol used by the service mediation and aggregation logic and a second protocol used by one of the plurality of network entities, based on stored element protocol configuration information.

According to yet another aspect, the subject matter described herein includes a method for providing service interaction and mediation in a communications network. The method includes receiving, at a service capability interaction manager (SCIM) module for performing service interaction and mediation between a service client and multiple application servers providing different services, a client to a client-to-SCIM service interaction message from a service client, and, in response to receiving the client-to-SCIM message, generating multiple SCIM-to-server messages and sending the SCIM-to-server messages to multiple application servers. The method also includes receiving multiple server-to-SCIM service interaction messages from at least some of the application servers that received the SCIM-to-server messages, and, in response to receiving the server-to-SCIM messages, generating a SCIM-to-client message containing an aggregation of at least a portion of data from at least some of the server-to-SCIM messages, and sending the SCIM-to-client message containing the aggregation to the service client.

According to yet another aspect, the subject matter described herein includes a method for providing rules-based service interaction and mediation in a communications network. As used herein, the term “rule” refers to a description of the response of an entity to particular stimuli, and the term “rules-based” refers to behavior that is determined at least in part by the operation of one or more rules. The method includes receiving, at a service capability interaction manager (SCIM) module for performing service interaction and mediation between a service client and a plurality of application servers providing different services, at least one incoming service interaction message; using a component of one of the incoming messages to identify a service interaction and mediation rule in a service interaction and mediation rules database that is operatively associated with the service capability interaction manager module and is for storing service interaction and mediation rules for performing service interaction and mediation; and using the identified rule to generate and send at least one outgoing message.

According to yet another aspect, the subject matter described herein includes a method for providing service interaction and mediation in a communications network. The method includes, at a service capability interaction manager (SCIM) module for performing service interaction and mediation between a service client and a plurality of network entities: receiving a service interaction message including information identifying a subscriber; identifying an event, occurring at the service client and associated with the identified subscriber, for which notification is desired; identifying at least one of the plurality of network entities for receiving notification of the identified event; maintaining mappings between the identified network entities and the identified event; and sending, to the service client, a request to send notifications of the identified event to the SCIM module.

The subject matter described herein for systems, methods, and computer program products for providing service interaction and mediation in a communications network may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer perform steps.

Exemplary computer readable media suitable for implementing the subject matter described herein include disk memory devices, chip memory devices, programmable logic devices, and application specific integrated circuits. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram illustrating an exemplary system for providing service interaction and mediation in a communications network in accordance with an embodiment of the subject matter described herein;

FIG. 2 is a flow chart illustrating an exemplary process for providing service interaction and mediation in a communication network in accordance with an embodiment of the subject matter described herein;

FIG. 3 is a flow chart illustrating an exemplary process for managing message subscription and notification in a communications network in accordance with an embodiment of the subject matter described herein;

FIG. 4 is a block diagram illustrating an exemplary system for providing rules-based service interaction and mediation in a communications network in accordance with another embodiment of the subject matter described herein;

FIG. 5 is a flow chart illustrating an exemplary process for providing rules-based service interaction and mediation in a communications network in accordance with an embodiment of the subject matter described herein;

FIG. 6 is a flow chart illustrating the operation of an exemplary system for providing rules-based service interaction and mediation in a communications network in accordance with an embodiment of the subject matter described herein;

FIG. 7 is signaling message flow diagram illustrating in more detail exemplary messages communicated between a service client network entity and two application servers in accordance with an embodiment of the subject matter described herein, showing examples of multiple message issue and aggregation from both directions;

FIG. 8 is signaling message flow diagram illustrating in more detail exemplary messages communicated between a service client network entity and two application servers in accordance with an embodiment of the subject matter described herein;

FIG. 9A is a block diagram illustrating an exemplary system for providing service interaction and mediation in a communications network in accordance with another embodiment of the subject matter described herein;

FIG. 9B is a block diagram illustrating an exemplary system for providing service interaction and mediation in a communications network in accordance with another embodiment of the subject matter described herein;

FIG. 10 is a block diagram illustrating an exemplary system for providing service interaction and mediation in a communications network in accordance with another embodiment of the subject matter described herein;

FIG. 11 is a block diagram illustrating an exemplary system for providing service interaction and mediation in a communications network in accordance with another embodiment of the subject matter described herein; and

FIG. 12 is a flow chart illustrating an exemplary process for providing service interaction and mediation in a communication network in accordance with another embodiment of the subject matter described herein.

### DETAILED DESCRIPTION

In accordance with the subject matter disclosed herein, systems, methods, and computer program products for providing service interaction and mediation in a communications network are provided. The subject matter described herein enables pre-IMS network elements to access SIP-enabled services, allows GSM elements to access IP services, and allows IMS/CSCF to access CAMEL/IN services.

In one embodiment, multiple service request messages may be generated from a single service trigger, and multiple service response messages may be aggregated into a single response message. A single service trigger may be translated into or used to trigger the generation of multiple additional service triggers, which enables multiple feature invocation and interaction involving any number of communications protocols including SIP, CAMEL, and IN protocols.

In another embodiment, service interaction and mediation may be based on service interaction and mediation rules, which may be stored in a service interaction and mediation rules database.

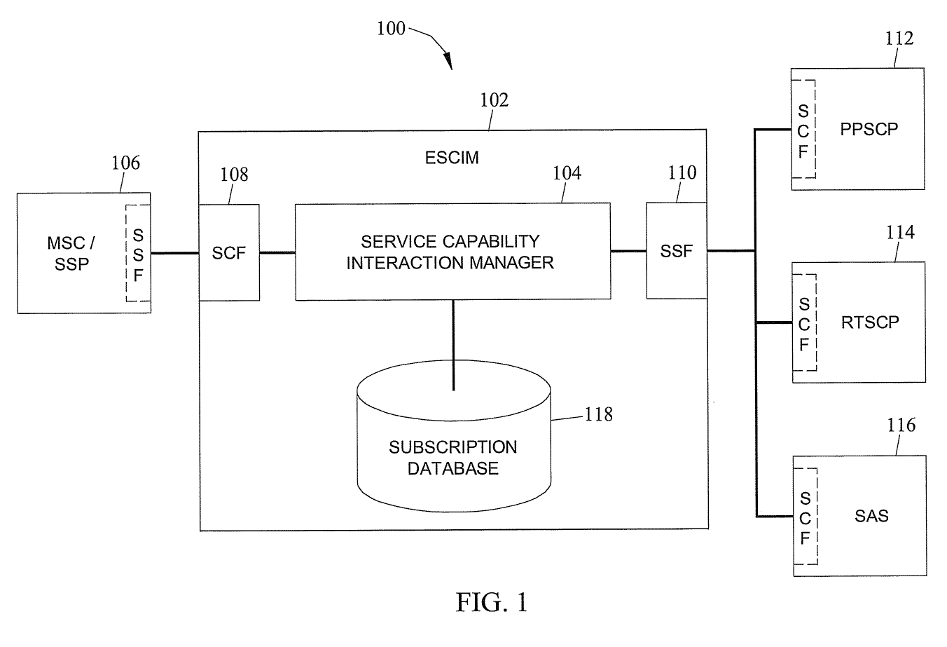

FIG. 1 is a block diagram illustrating an exemplary system for providing service interaction and mediation in a communications network in accordance with an embodiment of the subject matter described herein.

In one embodiment, system 100 may include an enhanced service capability interaction manager ESCIM 102 for providing service interaction and mediation, including receiving a service trigger message from a client, generating multiple service request messages, and aggregating the associated responses. A service request message may include a service trigger message (e.g., initial detection point message), a service query message, or other message containing information associated with a communications service subscriber. ESCIM 102 may include a service capability interaction manager module (SCIM module 104) for providing service interaction between a service client 106 and multiple application servers providing different types of services.

SCIM module 104 may communicate with service client 106 via a first communications interface, such as a service control function (SCF 108), for receiving client-to-SCIM messages and for sending SCIM-to-client messages. In one embodiment, SCF 108 may perform protocol conversion between a protocol used by service client 106 and a different protocol, such as an internal protocol used by SCIM module 104 and/or a protocol used by an application server. For example, SCIM module 104 may use a SIP protocol for all internal operations, while a message from service client 106, such as an initial detection point (IDP) message, may use a non-SIP protocol, such as an IN protocol. In this case, SCF 108 may convert a client-to-SCIM message from IN protocol to SIP protocol before passing the message to SCIM module 104 for internal processing. Similarly, SCF 108 may convert a SCIM-to-client message from SIP protocol to IN protocol before sending the message to service client 106.

SCIM module 104 may communicate with application servers via a second communications interface, such as a service switching point (SSF 110), for receiving server-to-SCIM messages and for sending SCIM-to-server messages. In one embodiment, SSF 110 may perform protocol conversion between a protocol used by an application server, such as PPSCP 112 or RTSCP 114, and a different protocol, such as an internal protocol used by SCIM module 104 and/or a protocol used by service client 106. For example, SCIM module 104 may use an AIN protocol internally, while PPSCP 112 may use a CAMEL protocol, in which case SSF 110 may convert a server-to-SCIM message from CAMEL protocol to an internal protocol (e.g., AIN) before passing the message to SCIM module 104. Similarly, SSF 110 may convert a SCIM-to-server message from AIN protocol to CAMEL protocol before sending the message to the application server.

In one embodiment, service client 106 may be a mobile switching center (MSC), a service switching point (SSP), or other network entity that may request network services. The application servers may include system control points (SCPs), session initiation protocol (SIP) application servers (SAS), simple object application protocol (SOAP) servers, or other network entity that may provide network services. For example, system 100 may include a prepaid SCP (PPSCP 112) for managing prepaid subscriber accounts, a ringback tones SCP (RTSCP 114) for providing ringback tones whereby a calling party hears the called party's custom music or message instead of the default sound sent to a calling party to indicate that the called party's phone is ringing, and a SIP application server (SAS 116) for providing SIP-based services.

SCIM module 104 may perform service interaction. In one embodiment, SCIM module 104 receives a client-to-SCIM service interaction message, and, in response to receiving the client-to-SCIM message, generates multiple SCIM-to-server messages and sends the SCIM-to-server messages to multiple application servers. SCIM module 104 may receive multiple server-to-SCIM service interaction messages from at least some-of the multiple application servers that received the SCIM-to-server messages, and, in response to receiving the server-to-SCIM messages, generate a SCIM-to-client message containing an aggregation of at least a portion of data from at least some of the server-to-SCIM messages, and send the SCIM-to-client message containing the aggregation to the service client via the communications interface.

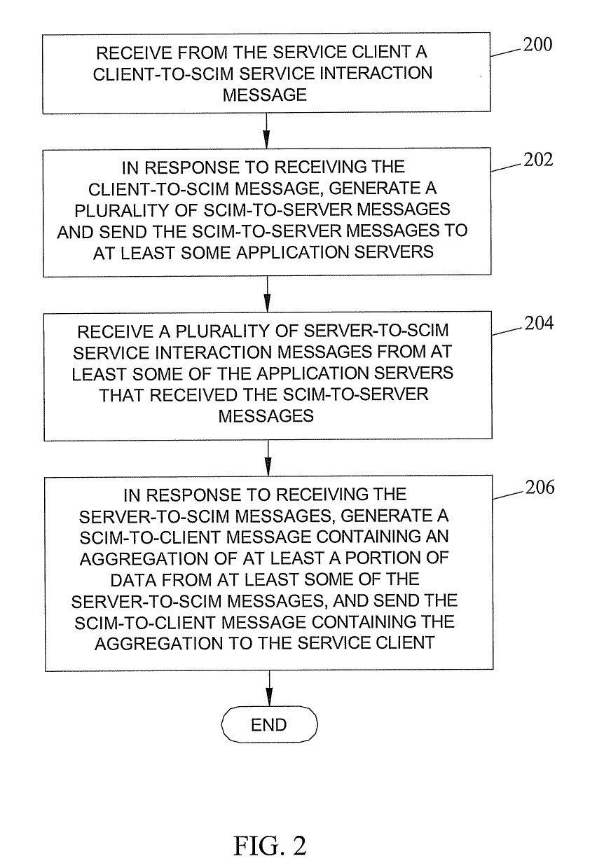

FIG. 2 is a flow chart illustrating an exemplary process for providing service interaction and mediation in a communication network in accordance with an embodiment of the subject matter described herein.

At block 200, a client-to-SCIM service interaction message is received from service client 106. For example, ESCIM 102 may receive an initial detection point (IDP) message in AIN protocol from a service switching point (SSP), or an IDP message in CAMEL protocol from a MSC.

In one embodiment, a communications interface, such as service control function SCF 108, may perform a mediation function to convert the incoming message to an internal protocol. For example, ESCIM 102 may use a SIP protocol internally, in which case SCF 108 may convert the incoming AIN or CAMEL protocol message to a SIP protocol before passing the converted message to SCIM module 104. Alternatively, the protocol conversion may be performed by SCIM module 104.

At block 202, in response to receiving the client-to-SCIM message, multiple SCIM-to-server messages may be generated and sent to at least some of the application servers. For example, SCIM module 104 generate and send two SCIM-to-server messages: a prepaid query to PPSCP 112 to determine whether a prepaid calling and/or called party has a sufficient prepaid account balance, and a ringback tones service request to RTSCP 114, requesting that the called party's custom ringback tone be sent to the calling party while the calling party waits for the called party to complete the connection.

In one embodiment, a component within ESCIM 102, such as SSF 110, may perform a mediation function to convert the SCIM-to-server messages from either a protocol used by service client 106 or an internal protocol used by SCIM module 104 to a protocol used by an application server. For example, if ESCIM 102 uses a SIP protocol internally, PPSCP 112 uses an IN protocol, and RTSCP 114 uses a CAMEL protocol, SCIM module 104 may generate the prepaid query and ringback tones service requests in SIP protocol and pass the service requests to SSF 110. SSF 110 may then convert the messages into IN protocol and CAMEL protocol, respectively, before sending the queries to their respective destinations. Alternatively, another component within ESCIM 102, such as SCIM module 104, may perform the protocol conversion.

At block 204, multiple server-to-SCIM messages may be received from at least some of the application servers that received the SCIM-to-server messages. For example, as the application servers receive their representative messages from ESCIM 102, they may send response messages to ESCIM 102 in reply. PPSCP 112 and RTSCP 114 may each generate a response to their respective queries, and their responses may be received by ESCIM 102.

In one embodiment, a component within ESCIM 102, such as SSF 110, may convert the server-to-SCIM messages from their external protocols to the internal protocol used by ESCIM 102 before passing the server-to-SCIM message to SCIM module 104. For example, SSF 110 may convert the prepaid query response received from PPSCP 112 from an IN protocol into an internal SIP protocol, and convert the ringback tones service request response received from RTSCP 114 from a CAMEL protocol into an internal SIP protocol, before forwarding the converted message to SCIM module 104. Alternatively, another component within ESCIM 102, such as SCIM module 104, may perform the protocol conversion.

At block 206, in response to receiving the server-to-SCIM messages, a SCIM-to-client message may be generated, containing an aggregation of at least a portion of data from at least some of the server-to-SCIM messages, and sent to the service client. For example, both PPSCP 112 and RTSCP 114 may respond to their respective queries and service requests with a “service denied” message, in which case SCIM module 104 may aggregate the multiple responses into a single “service denied” message and send a message containing the aggregated response to service client 106. In this manner, service client 106 will receive only a single response to its single IDP. Similarly, SCIM module 104 may aggregate multiple “service allowed” messages into a single “service allowed” message, which it will send to service client 106.

SCIM module 104 may receive conflicting messages, which must be resolved. For example, SCIM module 104 may receive a “service allowed” message from PPSCP 112 (e.g., indicating that the prepaid subscribers have sufficient funds to allow access to the network) and a “service denied” message from RTSCP 114 (e.g., indicating that the called party is not configured to send a custom ringback tone to the calling party). In this scenario, SCIM module 104 may determine that the call should continue without a custom ringback tone, in which case SCIM module 104 may generate and send a single “connect” message to service client 106 to indicate that the call should continue. On the other hand, if RTSCP 114 returns a “service allowed” message (e.g., the called party has a custom ringback tone that is to be played to the calling party while the calling party is waiting for the called party to answer the phone), but PPSCP 112 returns a “service denied” message (e.g., the calling party is a prepaid subscriber with an insufficient prepaid account balance), SCIM module 104 may generate and send a single “don't connect” message to service client 106 to indicate that access to the network was denied.

According to another embodiment of the present invention, SCIM function 104 is adapted to provide intelligent “error” handling logic in the course of applying service interaction and service orchestration rules. For instance, using the previous example, SCIM function 104 receives a single service trigger message from service client 106. In response to receiving the service trigger message, SCIM function 104 first generates a SCIM-to-server message that is forwarded to PPSCP 112. If PPSCP 112 responds to SCIM function 104 with an “error” indication, then SCIM function 104 does not generate a second SCIM-to-server message towards RTSCP 114. Instead, SCIM function 104 generates a single “don't connect” message to service client 106 to indicate that access to the network was denied. In yet another example of intelligent error handling, if SCIM function 104 first generates a SCIM-to-server message that is forwarded to PPSCP 112 and does not receive a response from PPSCP 112 (e.g., PPSCP 112 is unavailable/failed), then SCIM function 104 does not generate a second SCIM-to-server message towards RTSCP 114. Instead, SCIM function 104 generates a single “don't connect” message to service client 106 to indicate that access to the network was denied. In this manner, service nodes such as SCPs and SIP applications servers may be shielded from unnecessary queries.

In addition to managing requests that issue from service client 106 and aggregating the responses from the application servers, SCIM module 104 must also manage the reverse scenario—where requests are issued from multiple application servers and responses to those requests come from service client 106. Unlike the examples presented above, where SCIM module 104 may broadcast a request and aggregate the responses, in the following examples, SCIM module 104 may aggregate the requests and broadcast the responses. For example, an application server may request to be notified whenever a specified event occurs at service client 106. One example of this manner of operation is a publish and subscribe (pub/sub) system. In the context of a service switching point, such functionality is typically implemented through the use of service triggers which may be statically armed through provisioning or dynamically armed by an SCP/application server. Referring to FIG. 1, in one embodiment, system 100 may contain a subscription database 208 for maintaining publication and subscription information.

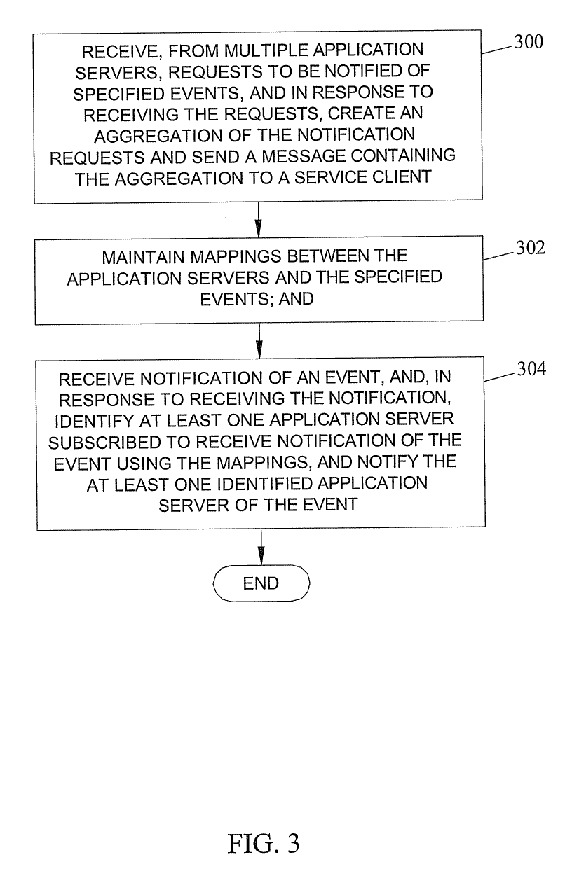

FIG. 3 is a flow chart illustrating an exemplary process for managing message subscription and notification in a communications network in accordance with an embodiment of the subject matter described herein.

At block 300, multiple requests to be notified of specified events are received from multiple application servers. For example, multiple SCPs or application servers may generate and send to the SCIM function multiple requests to arm the same service trigger at an SSP. The multiple requests are aggregated into a single notification request message, which is sent to a service client. For example, after an initial IDP is sent from service client 106 through SCIM module 104 to multiple applications servers, one or more application servers may issue requests to subscribe to notification of certain events that may occur on the service client 106. In this example, SCIM module 104 may receive a report basic call state model (RRB) request, RRB(E1, E2), from PPSCP 112, asking to be notified of the occurrence of event “E1” or event “E2”. SCIM module 104 may receive another RRB request, RRB(E1,E3), from RTSCP 114, asking to be notified of the occurrence of event “E1” or event “E3”. In one embodiment, SCIM module 104 may aggregate the separate RRB requests into a single RRB request, RRB(E1,E2,E3), asking to be notified of the occurrence of either event “E1”, “E2”, or “E3”, and send the aggregated single request to service client 106.

Thus, from the perspective of service client 106, ESCIM 102 looks like a single application server that is asking for notification whenever specified events occur. When any or the specified events do occur, service client 106 may issue a notification message to ESCIM 102. ESCIM 102 has the responsibility to make sure that the subscribed application servers receive proper notice of the pertinent events.

At block 302, mappings between the application servers and the specified events are maintained. In one embodiment, SCIM module 104 may use subscription database 208 to store and maintain lists of which applications servers should be notified for which events.

In one embodiment, for each message received by SCIM module 104, such as subscription requests and notification requests, the service type associated with the request is determined. Example service types include notification or publish/subscribe services, charging services, and the like. An application server that is associated with the determined service type is subscribed to receive notification of events associated with that service type.

For example, upon receipt of an RRB(EL) request from PPSCP 112, SCIM module 104 may create a list of application servers that should be notified of the occurrence of event E1, if such a list does not already exist, and add PPSCP 112 to that list. Upon receipt of an RRB(E1,E2) request from RTSCP 114, for example, SCIM module 104 may add RTSCP 114 to the list of application servers that should be notified if event E1 occurs, create a list of application servers that should be notified if event E2 occurs, and add RTSCP 114 to that list.

At block 304, a notification of an event is received. The mappings are used to identify which application servers are subscribed to receive notification of the event, and the identified application servers are notified of the event. For example, service client 106 may issue a client-to-SCIM message notifying ESCIM 102 of the occurrence of charging event E2. The client-to-SCIM message is processed by SCIM module 104, which may identify which of the application servers should receive notification and send notification to the identified application servers.

In one embodiment, SCIM module 104 may query subscription database 208 using the event or service type to identify which list or lists of servers should receive notification messages, and send notification messages to each application server included in the identified list or lists. For example, if event E2 occurs, service client 106 may issue a first event report BCSM (ERB) message, ERB(E2), to ESCIM 102. SCIM module 104 may determine that it is being notified of the occurrence of event E2, retrieve the list of application servers to be notified if event E2 occurs, and send notification messages to each application server on the retrieved list. In this example, SCIM module 104 which may determine that only RTSCP 114 is subscribed to receive notification of event E2, in which case ESCIM 102 may notify RTSCP 114 of the occurrence of event E2 by publishing the ERB(E2) message (e.g., forwarding a copy of the ERB(E2) message) to RTSCP 114.

Continuing the example above, if event E1 occurs, service client 106 may issue a second (ERB) message, ERB(E1), to SCIM module 104. When SCIM module 104 receives the ERB(E1) message, it may determine that both PPSCP 112 and RTSCP 114 are subscribed to receive notification of event E1. In one embodiment, SCIM module 104 may determine which application servers are subscribed by checking its list of E1 subscribers. SCIM module 104 may forward the ERB(E1) message or otherwise issue an event notification message to both PPSCP 112 and RTSCP 114.

In yet another example, SCIM module 104 may receive an apply charging (ACH) message from one or more application servers, such as from PPSCP 112 and RTSCP 114. SCIM module 104 may aggregate the multiple messages into a single ACH message, which is then sent to service client 106. SCIM module 104 may maintain charging service subscription information, such as a list identifying PPSCP 112 and RTSCP 114 as application servers that should be notified in the event of receipt of an apply charging report (ACR) message from service client 106. If SCIM module 104 later receives an ACR message from service client 106, SCIM module 104 may publish the ACR message to those application servers identified as being subscribed to receive these messages. For example, SCIM module 104 may, based on its subscription information, send separate ACR messages to each of PPSCP 112 and RTSCP 114.

The service mediation and protocol conversion functions described in sections above may be performed in concert with the publication and subscription functions.

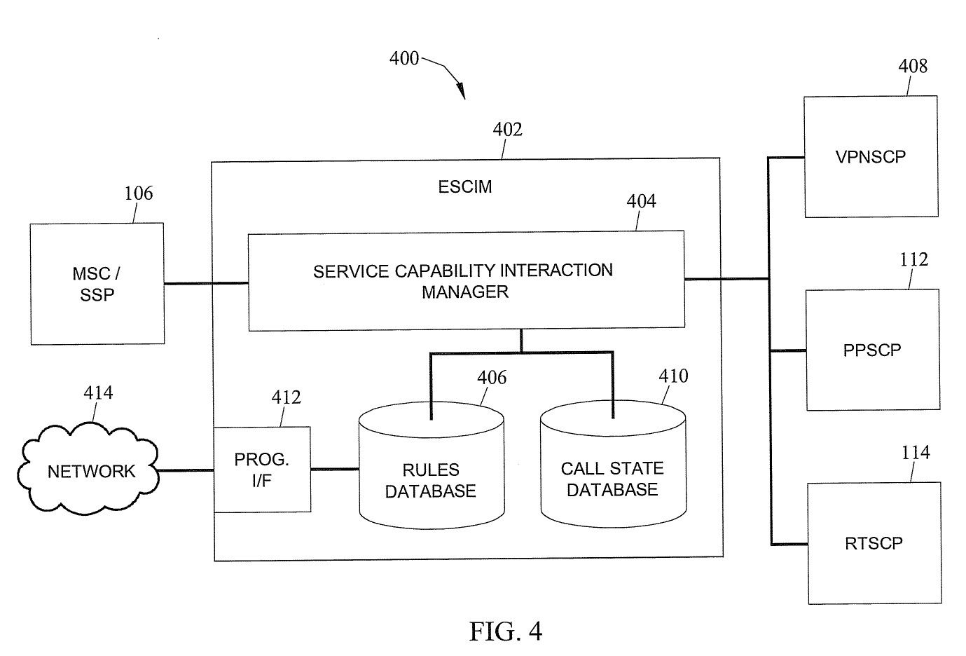

FIG. 4 is a block diagram illustrating an exemplary system for providing rules-based service interaction and mediation in a communications network in accordance with another embodiment of the subject matter described herein. In one embodiment, system 400 may include an enhanced service capability interaction manager ESCIM 402 for providing service interaction and mediation. ESCIM 402 may include a service capability interaction manager module (SCIM module 404), which uses service interaction and mediation rules stored in a service interaction and mediation rules database 406 to provide service interaction and mediation between service client 106 and a plurality of application servers providing different types of services.

Conceptually, a rule defines how a module or entity responds in a particular situation and/or to particular stimuli. Example rules in a rules-based SCIM might include: “If an IDP is received from an MSC or SSP, check to see if the calling party is a prepaid subscriber, and, if so, send a query to a prepaid SCP asking if the subscriber's prepaid account balance is sufficient to be allowed access”; and “If the prepaid SCP sends a message indicating that subscriber X does not have a sufficient prepaid account balance, terminate subscriber X's call”. A script is a combination or sequence of rules. A script may be used to define more complicated interactions, including interactions that require maintenance of state information, such as stateful transactions. A script may define a sequence of messages, such as queries and responses, that should be exchanged between the SCIM module 404 and one or more application servers. For example, a script may define the interoperability of multiple CAMEL/IN-based products that utilize the same CAMEL/IN trigger. Scripts may be comprised of literal and abstract terms and logical operators that are easily interpreted and understood by a human operator. A human operator may compose a SCIM rule by assembling terms and logical operators so as to define a service interaction rule. It will be appreciated that the exemplary rules referred to below are plain English language equivalents, and that a SCIM rule may assume a variety of forms depending upon the set of literal and abstract terms used in a particular SCIM system.

A script may define rules that operate in series. For example, a script may include a first rule, “If a prepaid subscriber has an insufficient balance, send a text message to the subscriber asking for permission to replenish his prepaid minutes by billing his credit card”, and a second rule, “If permission is received from a prepaid subscriber to replenish his prepaid minutes, send a electronic funds transaction request to the subscriber's credit card company, requesting a transfer of funds from his credit card to purchase additional prepaid minutes”. According to one embodiment, user configurable SCIM rules are maintained in a table-driven environment. Consequently, SCIM rules defining how interactions among multiple services are to be handled may be quickly and easily configured on a per-service basis (i.e., same behavior for all subscribers of a service), on a subscriber-by-subscriber basis, or a combination of both.

In one embodiment, a script may be associated with a combination of services available to a particular subscriber, such as a mediation service package, a calling plan, and the like. For example, a first subscriber's account or calling plan may be a prepaid account with custom ringback tones, while a second subscriber's account may be a non-prepaid account with VPN service.

In one embodiment, SCIM module 404 may select a service interaction and mediation language script based on a subscriber's calling plan, where the script defines the combination of services, such as prepaid, ringback tone, and VPN service, that is available to that subscriber. SCIM module 404 may then execute the selected service interaction and mediation language script.

In one example, SCIM module 404 may determine the calling party is a prepaid subscriber and the called party is a ringback tones subscriber, and therefore two services, prepaid and ringback tones, must be requested in response to the IDP message. Based on the results of this service key/subscriber ID analysis, SCIM module 404 may select a service interaction and mediation script from rules database 406 that is designed for the “prepaid calling party+ringback tones” subscriber. SCIM module 404 may then execute the selected script. The script being executed by SCIM module 404 may direct SCIM module 404 to send multiple messages related to the first IDP message; in this example, SCIM module 404 may send a prepaid service request message to PPSCP 112 in order to determine whether the calling subscriber has a sufficient prepaid account balance to be allowed access to the network, and SCIM module 404 may also send a ringback tones request message to RTSCP 114 requesting the called party's custom ringback tone.

In another example, during key and subscriber analysis of the original IDP message, SCIM module 404 may determine that the called party also is a prepaid subscriber. In that case, a different service interaction and mediation script, one which is designed for the “prepaid calling party+prepaid called party+ringback tones”, may be selected from rules database 406, in which case the script may issue a second prepaid query to RTSCP 114 in order to determine whether the called subscriber has a sufficient prepaid account balance.

A script may define rules that operate in parallel. For example, a script may include a first rule, “If an IDP trigger is received for a call from a prepaid caller, query the prepaid database to confirm that the calling party has a sufficient prepaid account balance to allow access to the network”, and a second rule, “If an IDP trigger is received for a call to a prepaid caller, query the prepaid database to confirm that the called party has a sufficient prepaid account balance to allow receipt of the call”. In this example, a single IDP message could trigger the operation of both rules, which could operate independently of each other. This is one example of a rules-based implementation of an entity, such as a SCIM, that can issue multiple SCIM-to-server service requests in response to a single client-to-SCIM service trigger.

As seen from the example immediately above, a SCIM may receive distinct responses from the two prepaid queries, which it may need to reconcile. How and when to reconcile multiple responses may also be defined by a rule. For example, a rules-based SCIM may include a rule such as “If a prepaid calling party has a sufficient account balance and a prepaid called party does not have a sufficient account balance, allow the call anyway if the prepaid called party is a premium subscriber (e.g., one who is not charged for incoming calls), but deny the call if the prepaid called party is a standard subscriber (e.g., one who is charged for incoming calls).” This is one example of a rules-based implementation of an entity, such as a SCIM, that can aggregate multiple server-to-SCIM response messages into a single SCIM-to-client response message.

Thus, there may be a rule (and associated response) for every combination of inputs. For example, there may be a rule for responding to an IDP from an MSC, a rule for responding to an IDP from an SSP, a rule for responding to a CONNECT from a prepaid SCP, a rule for responding to a CONNECT from a ringtones SCP, and so on.

Rules may be written in a hierarchical or modular fashion, such that common functions, such as a query to a prepaid database to determine whether a subscriber has a sufficient account balance, may be invoked by other functions. For example, the multi-instruction rule above might be written as “If an IDP is received from a prepaid subscriber that is calling another prepaid subscriber, invoke function CheckPrePaidBalance(“CallingParty”), and also invoke function CheckPrePaidBalance(“CalledParty”).” In another example, there may be a single rule for responding to all IDPs, and sub-rules which are invoked depending on whether the IDP came from an MSC or an SSP.

In one embodiment, rules may access tables and variables. Using variables allows great flexibility and a significant reduction in code size. For example, use of variables, tables, and parameters allows the creation of templates to cover a family of similar interactions, thus obviating the need to create a separate rule for every possible condition. Variables can be used for flow control conditions, such as if . . . then . . . else, while, and until. For example, a rule library may include a script or set of rules for managing call initiation and setup, another script or set of rules for managing service requests made during the call, another script or set of rules for managing call termination, yet another script or set of rules for managing billing, and so on. From the examples listed above, it can be seen that rules can define functional aspects of an entity, and that by changing the rules, the operation of the entity may be subtly or fundamentally changed. A rules-based entity may be contain a set of default rules that can be overridden or extended as needed. By providing a default set of rules, rules-based entities may be deployed and become operable with a minimum of configuration necessary, while at the same time having the flexibility to be configured to meet particular needs.

In one embodiment, rules database 406 may be a table. In alternative embodiments, rules database 406 may be a full-fledged database, a data structure, a memory, or other construct for storing data.

In one embodiment, service client 106 may be a mobile switching center (MSC), a service switching point (SSP), or other network entity that may request network services. The application servers may include system control points (SCPs), session initiation protocol (SIP) application servers (SAS), or other network entity that may provide network services. For example, system 400 may include a prepaid SCP (PPSCP 112) and a ringback tones SCP (RTSCP 114) as described above, and also a virtual private network SCP (VPNSCP 408).

In one embodiment, a portion of ESCIM 402, such as SCIM module 104, may perform protocol conversion between a protocol used by service client 106 and a different protocol, such as an internal protocol used by ESCIM 402 itself or one of its components and/or a protocol used by an application server. For example, ESCIM 102 may use a SIP protocol for all internal operations. In such embodiments, incoming messages, such as from service client 106 or an applications server, may be converted into a SIP protocol message by SCIM module 404. Similarly, SCIM module 104 may convert outgoing messages from an internal protocol into a different, external protocol. For example, SCIM module 104 may convert an outgoing message from SIP protocol into another protocol, such as IN or CAMEL, before the message is sent to an application server. Alternatively, another component within ESCIM 402 may perform the protocol conversion before passing the message. Protocol conversion includes conversion or harmonization of messages among different versions or phases of the same protocol (e.g., CAMEL phase 1, CAMEL phase 2, etc.).

In one embodiment, the service interaction and mediation rules stored in rules database 406 may define the sequence of operations that may be performed during particular service interactions. For example, a rule may define how ESCIM 402 should respond particular incoming messages, including sending multiple messages in response to service triggers and aggregating multiple messages into a single message; a rule may define how ESCIM 402 should treat particular subscribers; a rule may define how ESCIM 102 should communicate with particular network entities, etc.

In one embodiment, SCIM module 404 may use a component of an incoming message to identify a service interaction and mediation rule to apply. For example, a client-to-SCIM message, such as an IDP, may include a service key parameter, which may be detected by SCIM module 404 and used to choose an appropriate rule. Similarly, SCIM module 404 may detect information identifying subscribers, such as the called party and the calling party, and use that information to choose an appropriate rule. For example, SCIM module 404 may select between two rules depending on whether the calling party is a premium prepaid subscriber or a standard prepaid subscriber. In this scenario, a premium prepaid subscriber may be eligible to receive incoming messages regardless of the current prepaid account balance, in which case the script for handling an incoming call to a premium prepaid subscriber may not perform a prepaid balance query for the called party.

In one embodiment, ESCIM 402 may include a call state database 410 for storing and maintaining basic call state model (BCSM) call state information for each call being processed by ESCIM 402. In one embodiment, SCIM module 404 may use call state database 410 to temporarily store call state information for the duration of the call, after which the call state information may be deleted from call state database 410. Call state database 410 may store state values used during protocol mediation, such as in the case where a stateful protocol is being used.

In one embodiment, a programming interface 412 may be operatively coupled to rules database 406 to allow the contents of rules database 406 to be edited or modified remotely, such as across a network 414. In one embodiment, an operator may create rules on an entity other than ESCIM 402 and download the rules into rules database 406 via programming interface 412. In another embodiment, programming interface 412 may allow an operator to create or otherwise prepare or modify the contents of rules database 406 from a remote terminal, for example.

The following describes an example operation of a table-based implementation of a rules-based SCIM. In one embodiment, a rule or script is selected based on a parameter of an message received by the SCIM. One such parameter is the service key, which is a parameter included in a service request message. The service key may be used by the SCIM to determine the type of service that is being requested. The term “service key analysis” (or simply, “key analysis”,) refers to the process by which an incoming service request message is analyzed to determine what service is being requested. In one embodiment, service key analysis may return a service key, which may be a string, a number, or other token uniquely identifying the service being requested or the type of message received.

The service key may be used to select a rule or script from the rules database. For simplicity, for this example, the term “rule” will mean “rule, script, or other combination of rules”. The rules database may contain rules for service key analysis. An example service key analysis rule might be:
if Msg.ServiceKey=1 then Script=Process_IDP
   where a service key value of 1 indicates that the message received was an initial detection point (IDP) message and a script value “Process_IDP” is the name of a script for responding to an IDP. A user-programmable representation of this rule in XML format is:

```
<If>
    <ServiceKey>
        <Equals>1</Equals>
    </ServiceKey>
</If>
<Then>
    <Script>Process_IDP</Script>
</Then>
```

Table 1, below, is a possible internal table representation:

TABLE 1
Table Representation of a Rule

| Type | Sequence | Parameter | Operator | Value | Next |
|---|---|---|---|---|---|
| IDP | 1 | ServiceKey | IsEqualTo | 1 | Then |
| IDP | 2 | Script | SetTo | Process_IDP | End |

An example script, representing a call flow, is shown below in simplified form. The script shown below is an example implementation of the script “Process_IDP” referred to in the bottom row of Table 1, above. For simplicity, the script is represented in the form of procedural code rather than in a possible internal table representation. This example script is provided as an explanation of the subject matter and not as a limitation. Other content, forms, formats, and syntaxes are within the scope of the subject matter herein.

| 01 Process_IDP { | // Name of the script = “Process_IDP”. |
|---|---|
| 02 | |
| 03 EP-IDP: | // Name of the state machine. |
| 04 | |
| 05 START { | // Entry point for state “START”. |
| 06 @ IN (SSP, IDP=IDP1) { | // Trigger1 : receiving an IDP from a client |
| 07 | // SSP; IDP contents stored in data |
| 08 | // structure “IDP1”. |
| 09 OUT (AS1, IDP, IDP2, | // Send an IDP to application server |
| 10 IDP1.P1, PX, | // “AS1”, with parameter P1 from the |
| 11 SK=SK2); | // original IDP, a new parameter PX, |
| 12 | // while setting the service key to a new |
| 13 | // value, “SK2”. Store this IDP in data |
| 14 | // structure “IDP2”. |
| 15 START_TIMEOUT(IDP1); | // Start a timeout timer for an IDP |
| 16 WAIT (STATE1, IDP1); | // Transition to new state “STATE1”, |
| 17 | // save contents of IDP1 for later use. |
| 18 } | // End of response to trigger1. |
| 19 } | // End of state “START” |
| 20 | |
| 21 STATE1 { | // Entry point for state “STATE1”. |
| 22 @ IDP1.TIMEOUT { | // Trigger1 : no response from application |
| 23 | // server within timeout period set for IDP1. |
| 24 // No action | // Is action needed? Client that |
| 25 | // requested service typically keeps |
| 26 | // track of this. Alternatively, the script |
| 27 | // may instruct SCIM to send another |
| 28 | // IDP to another application server. |
| 29 } | // End of response to trigger1. |
| 30 | |
| 31 @ IN (AS1, RRB=RRB1, | // Trigger2 : receiving an RRB and CUE |
| 32 CUE=CUE1) { | // from server AS1, storing RRB and CUE |
| 33 | // parameters into data structures “RRB1” |
| 34 | // and “CUE1”, respectively. |
| 35 OUT (AS2, IDP, IDP3, | // Send an IDP to application server |
| 36 IDP2, SK=SK3); | // “AS2”, with same parameters as |
| 37 | // IDP2, but with a new service key |
| 38 | // value, “SK3”. Store this IDP in data |
| 39 | // structure “IDP3”. |
| 40 WAIT (STATE2, IDP1, | // Transition to new state “STATE2”, |
| 41 RRB1, CUE1); | // save contents of IDP1, RRB1, and |
| 42 | // CUE1 for later use. |
| 43 } | // End of response to trigger2. |
| 44 | |
| 45 @ IN (AS1, REL=REL1) { | // Trigger3 : Receiving a “REL” (release) |
| 46 | // from AS1. The REL parameters are |
| 47 | // stored in data structure “REL1”. |
| 48 OUT(SSP,REL1); | // Fwd the REL message to the SSP. |
| 49 } | // End of response to trigger3. |
| 50 DEFAULT { | // Default processing as specified by the |
| 51 // ... | // user. Useful for processing fall- |
| 52 } | // through conditions for aggregation or |
| 53 | // multiple-issue rules. |
| 54 } | // End of state “STATE1”. |
| 55 | |
| 56 STATE2 { | // Entry point for state “STATE2” |
| 57 @ IDP2.TIMEOUT { | // Trigger1 : no response from application |
| 58 | // server within timeout period set for IDP2. |
| 59 // no action | // Is action needed? |
| 60 } | // End of response to trigger1. |
| 61 | |
| 62 @ IN (AS2, RRB=RRB2, | // Trigger2 : receiving an RRB and CON |
| 63 CON=CON1) { | // from server AS2, storing RRB and CON |
| 64 | // parameters into data structures “RRB2” |
| 65 | // and “CON1”, respectively. |
| 66 OUT (SSP, RRB2, CON1); | // Fwd the RRB and CON to the SSP. |
| 67 EXIT (EP-IDP); | // Exit the state machine “EP-IDP”. |
| 68 } | // End of response to trigger2. |
| 69 | |
| 70 @ IN (AS2, REL) { | // Trigger3: Other possible responses from |
| 71 // ... | // AS2, such as a “REL” (release), should |
| 72 } | // be handled, also. |
| 73 | |
| 74 DEFAULT { | // Default processing as specified by the |
| 75 // ... | // user. Useful for processing fall-through |
| 76 } | // conditions for aggregation or multiple- |
| 77 | // issue rules. |
| 78 } | // End of state “STATE2”. |
| 79 | |
| 80 } | // End of script “Process_IDP”. |

As can be seen in the example script above, in one embodiment, a script may have a name, such as “Process_IDP”, and may define the operation of a state machine, named “EP-IDP”. The script may define the states in the state machine, such as “START”, “STATE1”, “STATE2”, etc. At each state, the state machine may wait for the occurrence of triggering events, or triggers. For example, execution of script “Process_IDP”, above, activates state machine “EP-IDP” and initializes the state machine to the START state. The state machine will continue to remain in the START state until an IDP is received from an SSP (line 06 of the script). In response to receipt of the IDP, the rules-based SCIM will issue its own IDP message to application server AS1 (line 09). This second IDP will include parameter P1 from the first IDP, will contain a new parameter, PX, and will overwrite the service key parameter, SK, with a new value to be sent to AS1. The SCIM will then start a timeout timer (line 15) to limit how long the SCIM will wait for a response from AS1 before moving on to the next step of the process or even abandoning the process entirely. State machine EP-IDP then moves to the next state, STATE1, making sure to store any state information necessary (line 16).

This example script illustrates several capabilities of a rules-based entity. First, a script, or a rule in a script, can execute other scripts or rules. For example, lines 15 and 16 may be calls to subroutines or functions named “START_TIMEOUT( )” and “WAIT( )”, respectively. Control flow may return from function or subroutine call, as in the case of the WAIT( ) function, or not, as in the case of the EXIT( ) function. Second, a script or rule can manipulate local and/or global variables, arrays, and data structures. For example, in line 06, a data structure named “IDP1” is created to hold all or part of the incoming IDP message, and in line 10, a part of that structure—message parameter “P1” from the original IDP message—is read via a reference to “IDP1.P1” and copied into outgoing message IDP2. Third, multiple states may be defined for the state machine (e.g., lines 05, 21, and 56), and each state may respond to multiple distinct events or triggers (e.g., lines 22, 31, 45, and 50 for state “STATE1”).

In one embodiment, rules database 406 may contain aggregation rules for determining how to combine or consolidate multiple messages into a single message and how to resolve conflicts between multiple, possibly contradictory, responses. For example, rules database 406 may include aggregation rules that may direct SCIM module 404 to aggregate multiple server-to-SCIM messages, such as event notification requests, into a single SCIM-to-client message, and which may direct or assist SCIM module 404 in creating an aggregated message. An aggregation rule may include conflict resolution rules to resolve and aggregate incompatible responses, such as in the examples above, where one application server returns a “service allowed” message while another application server returns a “service denied” message. Table 2, below, lists some example aggregation rules:

TABLE 2
Sample Aggregation Rules

| Message | Rule |
|---|---|
| RRB | Combine & Forward |
| CUE | Drop if CON response present |
| CON | (Nortel Specific) Forward |
| ACH | Forward |
| REL | Forward (Default rules based behavior) |

Table 2 can be more easily understood in the context of some background information. A request report BCSM event (RRB) message is a message, sent by an application server to a client, requesting that the client notify the application server of the occurrence of a particular event or events. For example, an RRB may request notification of a transition from one state to another state in the BCSM, the receipt of a particular type of message by the client, or the satisfaction of a specific set of conditions by the client. It is not uncommon that multiple application servers may be interested in the same event or condition at the client. For example, in general, all application servers actively providing a service during the life of a call want to be notified when the call is terminated, so that server resources may be released for use by another subscriber or process. However, there is no need to issue the same RRB message multiple times to the client every time another application server joins into (e.g., provides services for) a call. As can be seen from Table 2, above, the rule for RRB messages is “combine and forward”, indicating that although multiple application servers may issue RRB requests to the client, the SCIM will aggregate the multiple RRB requests into a single RRB request, which the SCIM forwards to the client.

In one embodiment, rules database 406 may contain rules for issuing multiple outgoing (e.g., SCIM-to-server) messages in response to receiving a single incoming (e.g., client-to-SCIM) message, such as a service request trigger; these rules are hereinafter referred to as “multiple-issue” rules. In general, a rule may be implicit or explicit. An implicit rule may operate to send messages to entities implicitly requesting message delivery. An explicit rule may operate to messages to entities explicitly requesting message delivery. For example, explicit rules may apply where a requesting entity expects a response to its query, while implicit rules may apply where a requesting entity seeks notification of an event that may or may not occur. The classification of rules generally and multiple-issue rules in particular as implicit or explicit is for conceptual illustration only, and is not a limitation of the contents or scope of the subject matter described herein.

An example of operation of an implicit rule is the scenario in which an application server sends to a switching point an establish temporary connect (ETC) message or other message to which the application server expects a response. An implicit rule could be “Responses to an ETC message should be forwarded to the entity that issued the ETC message.” An example of an implicit multi-issue rule is the scenario in which one or more application servers send apply charging (ACH) messages to client. An implicit multi-issue rule could be “Apply charging report (ACR) messages should be forwarded to any entity that issued an ACH message.”

An example of operation of an explicit multi-issue rule is the scenario where one or more application servers each send a request report BCSM event (RRB) message to a client. An explicit multi-issue rule could be “Any event report BCSM (ERB) message received from a client should be forwarded to all entities that sent RRB messages to that client.” The ERB rule is explicit because each RRB message is a request that expects a timely response. In contrast, the ACR rule is implicit because an ACH is not a request that expects a timely response, but merely a request for notification should a particular event occur. There is no guarantee that the event will ever occur.

In one embodiment, rules database 406 may include rules for service mediation. For example, a message sent to one application server may use a different protocol from a message sent to another application server. Commonly used protocols include CAMEL, IN and in variants, such as AIN and WIN, SIP, and other protocols. For example, if PPSCP 112 is a CAMEL-capable device, and RTSCP 114 is a non-CAMEL-capable device, such as an IN or AIN device, a component within ESCIM 102 is responsible for converting the service request message issued by SCIM module 404 from the internal protocol used by SCIM module 404 into a CAMEL protocol if the message is for PPSCP 112 or an AIN protocol if the message is for RTSCP 114.

In one embodiment, rules database 406 may include a set of error handling rules, so that only the expected (e.g., error-free) operation need be programmed explicitly. In one embodiment, rules database 406 may contain a set of default rules that define the default operation of the device, and which may be overridden. The use of default rules may allow for even simpler configuration, since only the non-standard expected operation need be programmed explicitly. Default rules for multiple-issue and aggregation would be particularly useful to aid the configuration of the device to support these capabilities.

One characteristic of a rules-based function that distinguishes it from a non-rules-based function is that the rules are distinct constructs from the processing engine or other entity that reads and processes the rules. Typically, the rules may change, but the engine used to process the rules does not change. This is in contrast to hard-coded functions, i.e., hardware or hard-wired logic, which are difficult or impossible to modify once deployed. This is also in contrast to software functions that are compiled to a binary image and executed, in which even a minor change to a function requires a recompile. For example, software functions written as procedural code typically require a new function or subroutine to be written to support a new feature, while software written in an object oriented fashion require either the creation of a new object type or modification of existing objects to support the new feature. In both cases, a non-rule-based engine requires modification to support the new subroutine, object class, etc. Even if the functions are written in an interpreted language, the program—including the new functions, subroutines, or objects—must be reinstalled. In contrast, a rules-based entity can be upgraded to support new functions and features by merely adding a new rule to the rules table or database. It is not necessary to modify the rules interpretation engine.

Furthermore, a rules-based entity, such as a SCIM, may be easier to customize. For example, a rules-based SCIM's ruleset may be tuned to support the combination of servers that it connects to, the combination of functions that it must support in the network, and even the brand of servers that it must communicate with. A rules-based entity may be easier to upgrade to new standards as standards change.

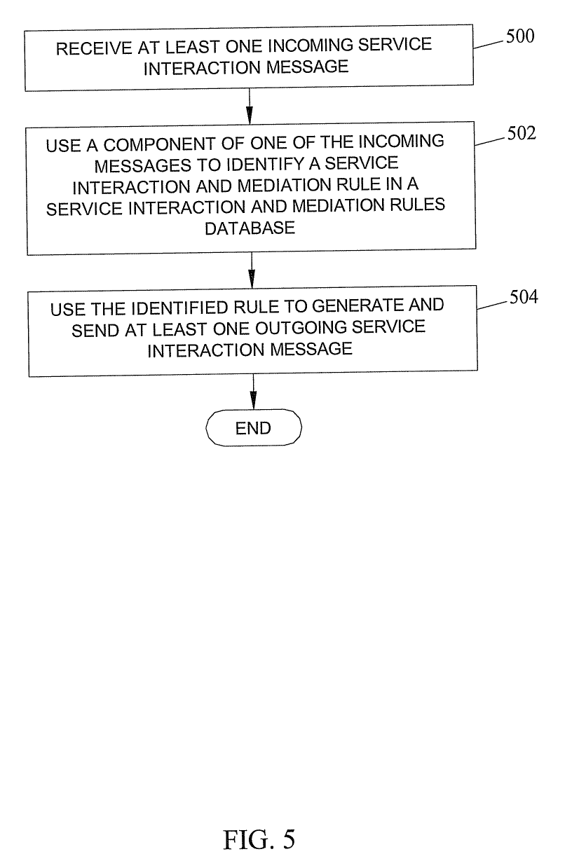

FIG. 5 is a flow chart illustrating an exemplary process for providing rules-based service interaction and mediation in a communications network in accordance with an embodiment of the subject matter described herein.

At block 500, at least one incoming service interaction message is received at a service capability interaction manager (SCIM) module for performing service interaction and mediation between a service client and a plurality of application servers providing different services.

At block 502, a component of one of the incoming messages is used to identify a service interaction and mediation rule contained in a service interaction and mediation rules database operatively associated with the service capability interaction manager module and for storing service interaction and mediation rules for performing service interaction and mediation, such as rules database 406. In one embodiment, rules database 406 may be co-located with SCIM module 404. In alternative embodiments, rules database 406 may not be co-located with SCIM module 404 but accessed remotely by SCIM module 404.

In one embodiment, SCIM module 404 may use a service key parameter and a subscriber identifier to determine which services are appropriate for a particular subscriber, which SCIM module 404 may then use in combination with the service key parameter to determine what service request messages should be issued to which application servers, and to choose the appropriate rule or script for that case. For example, ESCIM 102 may receive from service client 106 a message containing a service key parameter identifying the message as an IDP message, as well as subscriber information identifying the called and calling parties. SCIM module 404 may determine, based on the calling party's subscriber identifier, that the calling party is a prepaid subscriber. In this case, SCIM module 404 may determine that for an IDP, a query to PPSCP 112 is required to determine whether the calling party has a sufficient prepaid account balance, and choose the rule or script that includes this query step. On the other hand, if prepaid subscribers may receive unlimited text messages, for example, SCIM module 404 may determine that for a text message being sent to a prepaid subscriber, no query to PPSCP 112 is necessary, and choose the rule or script that does not include this query step.

At block 504, the identified rule is used to generate and send at least one outgoing service interaction message. In one embodiment, rules database 406 may include service interaction rules that may direct SCIM module 404to issue multiple SCIM-to-server messages, such as service request messages, in response to a client-to-SCIM message, such as a service request message or service trigger. Similarly, a rule may direct SCIM module 404 to issue multiple event notification messages to application servers in response to receiving an event notification message from the client. Example actions defined by a rule could include sending the same message to multiple application servers, sending unique messages to each of multiple application servers, sending multiple messages to one application server, sending multiple messages to multiple application servers, and so on.

The multiple messages may be sent serially, such as in a query/response environment, where SCIM module 404 may wait for the response to a first query before sending a second query, or the multiple messages may be sent in parallel, where SCIM module 404 may issue queries to multiple application servers without waiting for a response to the first query before sending the second query.

In one embodiment, rules for service interaction, aggregation, mediation, and so on, may be included in the service interaction and mediation scripts stored in rules database 406. In an alternative embodiment, the different types of rules may be segregated from each other. For example, service interaction and mediation scripts may call aggregation functions or make reference to aggregation rules stored in a separate aggregation rules table; interaction and aggregation rules may invoke mediation rules prior to sending outgoing messages; etc.

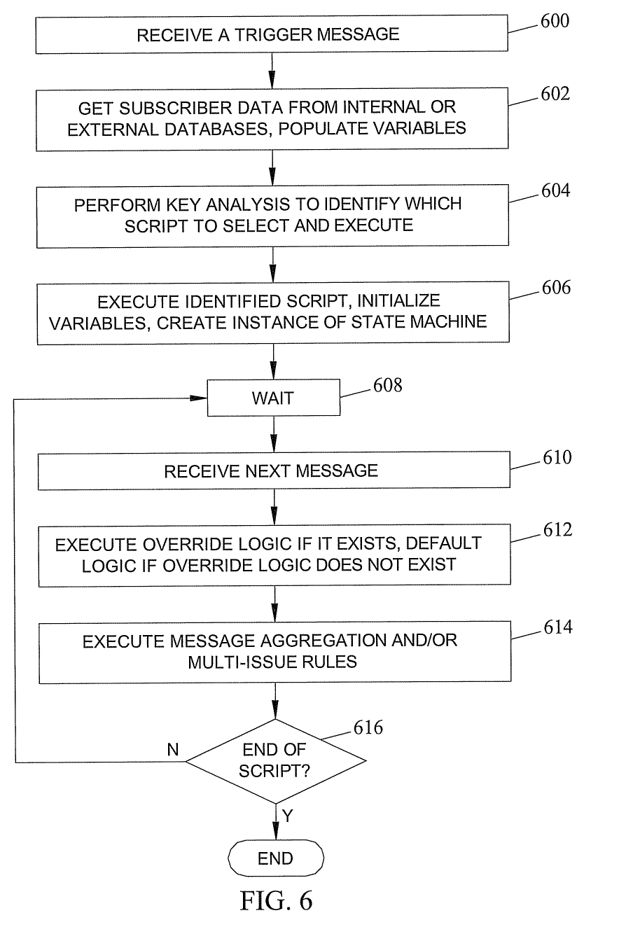

FIG. 6 is a flow chart illustrating in more detail the operation of an exemplary system for providing rules-based service interaction and mediation in a communications network in accordance with an embodiment of the subject matter described herein.

At block 600, a message is received at a rules-based ESCIM 402. The trigger message is of a type recognized by ESCIM 402 as being a trigger message. At block 602, SCIM module 404 may access internal and/or external databases in order to collect information about the subscriber associated with the message, such as the calling party, the called party, etc. The information collected may be used to populate variables to be used by the state machines. At block 604, the service key parameter from the incoming message is analyzed to determine which script to select for execution. At block 606, the identified script is selected, retrieved if necessary, and executed. An instance of a state machine may be created, and the initialization code of the state machine may be executed. At block 608, after the initialization code of the state machine has completed, the state machine waits until the arrival of another message.

At block 610, a second message associated with the same call as the first message, is received at ESCIM 402. At block 612, if the script includes a rule for the type of message received, that rule will be executed by SCIM module 404; if not, SCIM module 404 may execute default rules, stored in rules database 406, for the type of message received. At block 614, SCIM module 404 may retrieve and execute additional rules, such as aggregation and/or multi-issue rules, as applicable. At block 616, SCIM module 404 determines if the script has completed; if not, control returns to block 608 to wait for the next incoming message. Otherwise, the process ends, the state machine terminates, and the resources associated with the call, including variables, are freed.

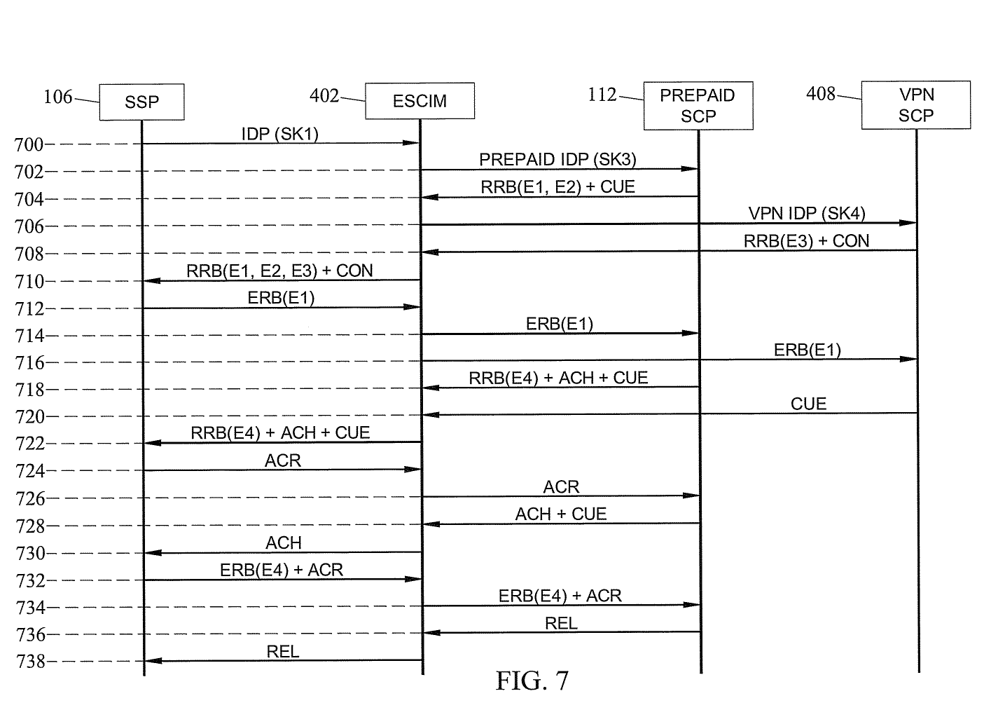

FIG. 7 is signaling message flow diagram illustrating in more detail exemplary messages communicated between a service client network entity and two application servers in accordance with an embodiment of the subject matter described herein, showing examples of multiple message issue and aggregation from both directions. In this figure, service client 106, a service switching point, and two application servers, PPSCP 112 and VPNSCP 408, communicate via service interaction and mediation node ESCIM 402. This process will now be described with reference to FIGS. 1 and 4.

Message 700 is an initial detection point (IDP) message that is sent from service client 106 to ESCIM 402. This message includes a service key parameter, SK1. Upon receipt of Message 700, SCIM module 404 extracts the service key from the incoming message, uses the service key to determine which service interaction and mediation script to execute, and retrieves the appropriate script from rules database 406. In this embodiment, execution of the service interaction and mediation language script may include interaction between two application servers, PPSCP 112 and VPNSCP 408, and the service client entity that issued the IDP, service client 106. This interaction is described in more detail below.

Message 702 is an IDP message issued by ESCIM 402 to PPSCP 112, according to the service interaction and mediation script that controls this service interaction and mediation session. IDP message 702 includes a service key parameter, SK3, from which PPSCP 112 can determine that the request is a query to a prepaid database.

Message 704 is a message issued from PPSCP 112 to ESCIM 402 in response to service request message 702. In this example, message 704 includes the parameters RBB(E1,E2) and CUE. The CUE, or CONTINUE, parameter indicates that call processing may continue, but does not actually connect the call. In this scenario, PPSCP 112 may intend to indicate not that the call should be connected, but only that the prepaid subscriber has a sufficient account balance. The RRB(E1,E2) parameter is a subscription request asking that PPSCP 112 be notified should either event E1 or event E2 occur. For example, event E1 may represent the caller hanging up the phone, and event E2 may represent the called party answering the call. SCIM module 404 may subscribe PPSCP 112 to receive notification of events E1 and E2 in a manner described above.

Message 706 is an IDP message issued by ESCIM 402 to VPNSCP 408, according to the service interaction and mediation script. IDP message 606 includes a service key parameter, SK4, from which VPNSCP 408 can determine that a virtual private network connection is being requested.

Message 708 is a message issued from VPNSCP 408 to ESCIM 402 in response to service request message 706. In this example, message 708 includes the parameters RRB(E3) and CON. The CON, or CONNECT, parameter indicates that the call may be connected; in this case, via a virtual private network connection, for example. The RRB(E3) parameter is a subscription request asking that VPNSCP 408 be notified of the occurrence of event E3. For example, event E3 may represent a busy signal from the called party. SCIM module 404 may subscribe VPNSCP 408 to receive notification of event E3 in a manner described above in reference to FIG. 3.

Message 710 is aggregation of the response messages 704 and 708 according to the service interaction and mediation script. In this example, message 710 includes the parameters RRB(E1,E2,E3) and CON. The RRB(E1,E2,E3) parameter is a request for notification of the occurrence of either of events E1, E2, or E3, and was created according to aggregation rules. The CON parameter was the result of application of service interaction and mediation rules to the conflicting responses CON and CUE.

Message 712 is an event report basic call state model (ERB) message issued from service client 106 to ESCIM 402 in response to the occurrence of an event at service client 106. In this example, message 712 includes parameter ERB(E1), which indicates that event El occurred. SCIM module 404 may determine that both PPSCP 112 and VPNSCP 408 are subscribed to receive notification of event E1. In one embodiment, SCIM module 404 may use a multiple message issue rule registry to make this determination.

Message 714 is an ERB(E1) message issued by ESCIM 402 in response to receiving message 712, to notify PPSCP 112 that event E1 occurred on service client 106.

Message 716 is an ERB(E1) message issued by ESCIM 402, also in response to receiving message 712, to notify VPNSCP 408 that event E1 occurred on service client 106.

Message 718 is a message issued from PPSCP 112 to ESCIM 402 in response to message 714. In this example, message 718 includes the parameters RRB(E4), ACH and CUE. The RRB(E4) parameter is a subscription request asking that PPSCP 112 be notified of the occurrence of event E4. For example, event E4 may represent the called party hanging up the phone. The ACH, or apply charging, parameter is a request asking service client 106 to send notification of any charging events. The CUE parameter has been described above. SCIM module 404 may subscribe PPSCP 112 to receive notification of event E4 in a manner described above. In a similar manner, SCIM module 404 may also subscribe PPSCP 112 to receive notification of any charging events.

Message 720 is a message issued from VPNSCP 408 to ESCIM 402 in response to message 716. In this example, message 720 includes the CUE parameter, described above.

Message 722 is an aggregation of the response messages 718 and 720 according to the service interaction and mediation script. In this example, message 722 includes the parameters RRB(E4), ACH and CUE.

Message 724 is an apply charging report (ACR) message issued from service client 106 to ESCIM 402 in response to the occurrence of a charging event at service client 106. In this example, SCIM module 404 may determine that only PPSCP 112 has subscribed to receive notification of an ACR message.

Message 726 is an ACR message issued from ESCIM 402 to PPSCP 112 according to a determination by SCIM module 404 that PPSCP 112 has subscribed to receive notification of ACR messages.

Message 728 is a message issued from PPSCP 112 to ESCIM 402 in response to receipt of message 726 by ESCIM 402. In this example, PPSCP 112 may receive ACR message 726, process the charging event, and the issue message 728 to indicate that PPSCP 112 would like to allow the call to continue, while continuing to be notified of subsequent charging events. On the other hand, if PPSCP 112 determined after receiving message 726 that a prepaid party had just depleted their prepaid account balance, PPSCP 112 may opt to issue another message, such as an instruction to terminate the call or to redirect the call to another application server for the purpose of allowing the prepaid party to add money to the his or her prepaid account balance, so that the call may continue, for example.

Message 730 is an ACH message issued from ESCIM 402 to service client 106. Message 730 is an aggregation of messages sent to SCIM module 404 from the application servers. In this example, only one message, message 728, was received to be aggregated, but SCIM module 404 determined that it was necessary only to forward the ACH parameter, and not the CUE parameter, to service client 106.

Message 732 is another notification message from service client 106 to ESCIM 402. In this example, message 732 contains the parameters ERB(E4) and ACR, indicating the occurrence of event E4 at service client 106 and a charging request, respectively. SCIM module 404 may determine that only PPSCP 112 is subscribed to receive notification of these events or requests.

Message 734 is a notification message published by ESCIM 402 to PPSCP 112 according to publication information maintained by SCIM module 404. In this example, message 734 indicates that the called party hung up the phone and is a notification of the occurrence of event E4 at service client 106.

Message 736 is a message sent by PPSCP 112 to ESCIM 402 in response to message 734. In this example, message 736 is a REL, or RELEASE, message, which indicates that the call should be released (i.e., disconnected.)

Message 738 is a message sent by ESCIM 402 to service client 106 in response to message 736. In this example, message 738 is the aggregation of a single message, and indicates to service client 106 that the call should be disconnected.

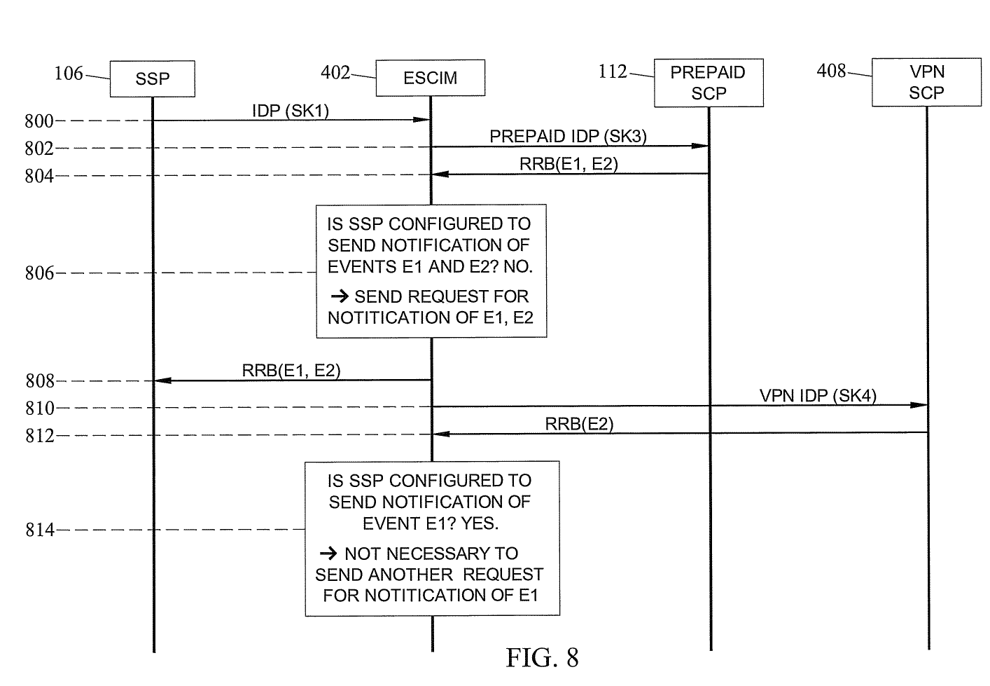

FIG. 8 is signaling message flow diagram illustrating in more detail exemplary messages communicated between a service client network entity and two application servers in accordance with an embodiment of the subject matter described herein. In this figure, service client 106, a service switching point, and two application servers, PPSCP 112 and VPNSCP 408, communicate via service interaction and mediation node ESCIM 402. This process will now be described with reference to FIGS. 1 and 4.

Message 800 is an initial detection point (IDP) message that is sent from service client 106 to ESCIM 402. This message includes a service key parameter, SK1. Upon receipt of Message 800, SCIM module 404 extracts the service key from the incoming message, uses the service key to determine which service interaction and mediation script to execute, and retrieves the appropriate script from rules database 406. In this embodiment, execution of the service interaction and mediation language script may include interaction between two application servers, PPSCP 112 and VPNSCP 408, and the service client entity that issued the IDP, service client 106. This interaction is described in more detail below.

Message 802 is an IDP message issued by ESCIM 402 to PPSCP 112, according to the service interaction and mediation script that controls this service interaction and mediation session. IDP message 802 includes a service key parameter, SK3, from which PPSCP 112 can determine that the request is a query to a prepaid database.

Message 804 is a message issued from PPSCP 112 to ESCIM 402 in response to service request message 802. In this example, message 804 includes the parameters RBB(E1,E2) and CUE. The CUE, or CONTINUE, parameter indicates that call processing may continue, but does not actually connect the call. In this scenario, PPSCP 112 may intend to indicate not that the call should be connected, but only that the prepaid subscriber has a sufficient account balance. The RRB(E1,E2) parameter is a subscription request asking that PPSCP 112 be notified should either event E1 or event E2 occur. For example, event E1 may represent the caller hanging up the phone, and event E2 may represent the called party answering the call. SCIM module 404 may subscribe PPSCP 112 to receive notification of events E1 and E2 in a manner described above.

At block 806, ESCIM 402 may maintain an association between a subscriber or call associated with the subscriber, one or more events, and one or more application servers. For example, ESCIM 402 may create an entry in call state database 410 to record that PPSCP 112 has requested notification of events E1 and E2 with respect to the call that triggered IDP message 800 or a subscriber associated with that call. ESCIM 402 may determine whether or not service client 106 has already been configured to issue such notifications, e.g., whether ESCIM 402 is subscribed to receive such notifications, and if not, attempt to configure service client 106 to send the desired notifications. In the example illustrated in FIG. 8, ESCIM 402 determines that it has not yet made any subscription requests to service client 106, in which case ESCIM 402 sends message 808 to service client 106 requesting notification events E1 and E2. In one embodiment, ESCIM may request notification of these events only as they pertain to a particular subscriber or call, or ESCIM may request notification of these events regardless of the subscriber, only for certain classes of subscribers, and so on.

Message 810 is an IDP message issued by ESCIM 402 to VPNSCP 408, according to the service interaction and mediation script. IDP message 810 includes a service key parameter, SK4, from which VPNSCP 408 can determine that a virtual private network connection is being requested.

Message 812 is a message issued from VPNSCP 408 to ESCIM 402 in response to service request message 810. In this example, message 812 includes the parameter RRB(E2), which is a subscription request asking that VPNSCP 408 be notified of the occurrence of event E2.

At block 814, ESCIM 402 determines whether or not service client 106 is configured to send notification of event E2. For example, ESCIM 402 may perform a lookup using call state database 410 and determine that service client 106 is already configured to send notification of events E1 and E2 to ESCIM 402, in which case ESCIM 402 determines that it is not necessary to send another RRB(E2) request to service client 106. In this manner, ESCIM 402 aggregates multiple RRBs, i.e., messages 804 and 812, into a single message 808, by suppressing subsequent redundant messages from ESCIM 402 to service client 106.

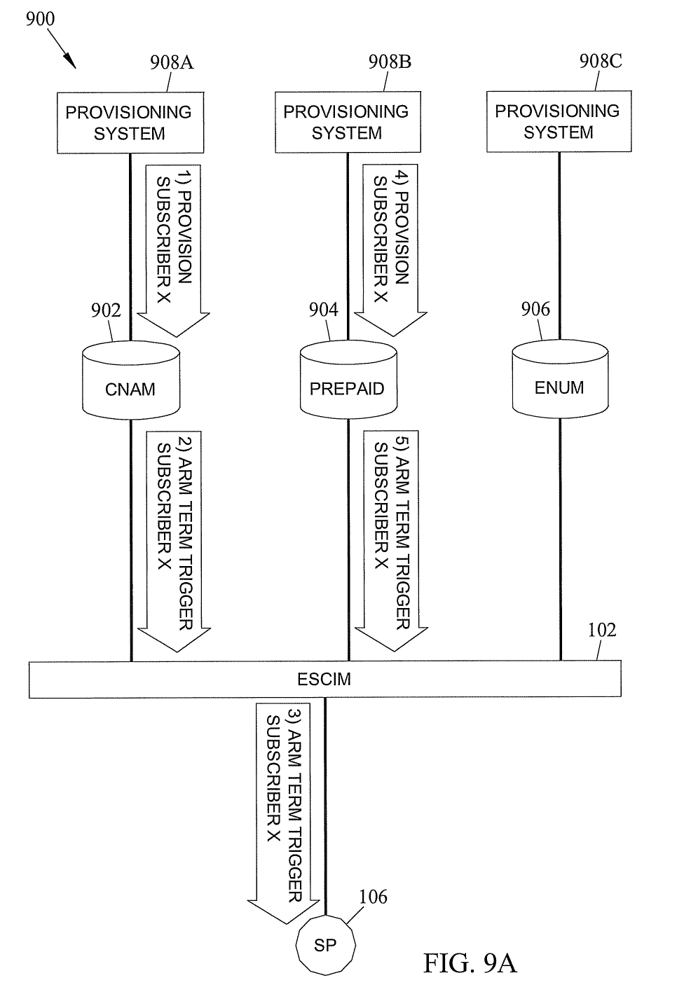

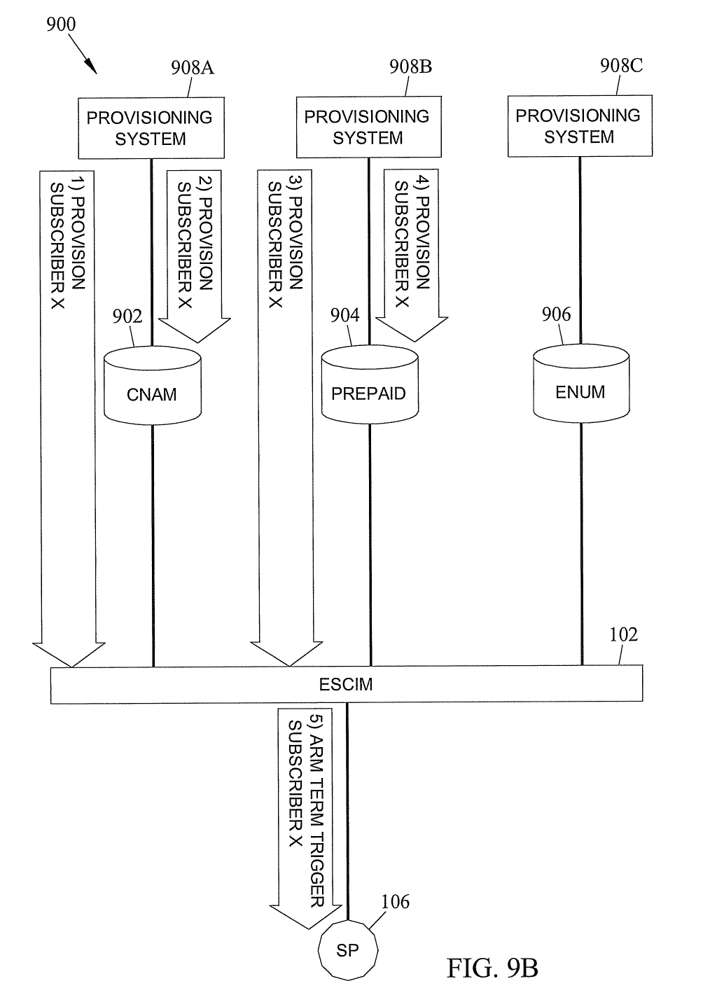

FIG. 9A is a block diagram illustrating an exemplary system for providing service interaction and mediation in a communications network in accordance with another embodiment of the subject matter described herein. In one embodiment, system 900 includes an ESCIM 102 and service client 106 as described in reference to FIG. 1, as well as multiple application servers for providing various functions. In the embodiment illustrated in FIG. 9A, CNAM 902 performs caller name (CNAM) lookups, PPSCP 904 hosts a prepaid database, and ENUM 906 performs E.164 (ENUM) lookups.

System 900 may include one or more provisioning systems 908. In one embodiment, there may be separate provisioning systems for each application server. For example, provisioning system 908A may provision CNAM 902, provisioning system 908B may be responsible for provisioning PPSCP 904, and provisioning system 908C may provision ENUM 906. For simplicity, provisioning systems 908A-C may be referred collectively as “provisioning system 908″. Other embodiments, such as a single provisioning system for all application servers and multiple provisioning systems responsible for provisioning one or more applications servers, are within the scope of the subject matter claimed herein.

An exemplary operation of system 900 will now be described with reference to FIG. 9A. Upon the occurrence of some provisioning event, such as the addition of a new subscriber to the network, one or more provisioning systems may send instructions to their respective application servers to provision the new subscriber, for example. In FIG. 9A, provisioning system 908A may send a provisioning request (message 1) to CNAM 902, requesting that subscriber X be added to the CNAM database. In response, CNAM 902 may send a subscription request to ESCIM 102. For example, CNAM 902 may send an arm term trigger message (message 2), requesting notification of events associated with subscriber X.

In one embodiment, ESCIM 102 may first determine, using a process similar to that described in block 806 of FIG. 8, above, whether an appropriate arm term trigger message has already been sent to service client 106. In the example illustrated in FIG. 9A, ESCIM 102 determines that it is necessary to send or forward an arm term trigger message (message 3) to service client 106.

Continuing this example, provisioning system 908B also sends a provision request (message 4) to PPSCP 904, which in turn sends an appropriate subscription request (message 5) to ESCIM 102. Here, ESCIM 102 may determine, using a process similar to that described in block 816 of FIG. 8, that an additional subscription request to service client 106 would be redundant, and so does not send an additional subscription request.

FIG. 9B is a block diagram illustrating an exemplary system for providing service interaction and mediation in a communications network in accordance with another embodiment of the subject matter described herein. The system illustrated in FIG. 9B is the same as that described in FIG. 9A, and thus the description will not be repeated herein.

In the embodiment illustrated in FIG. 9B, provisioning systems 908 may send provisioning messages directly to ESCIM 102 (messages 1 and 3) in addition to the normal messages sent to the application servers themselves (messages 2 and 4). In one embodiment, ESCIM 102 can determine, based on the provisioning messages received, which of subscriber X's events notification should be requested. For example, ESCIM 102 may determine that CNAM 902 may need notification only during call setup while PPSCP 904 may need notification of both call setup and takedown. In response to that determination, ESCIM 102 may send to service client 106 a subscription request to that effect (message 5) requesting notification of the pertinent events, i.e., call setup and call takedown.

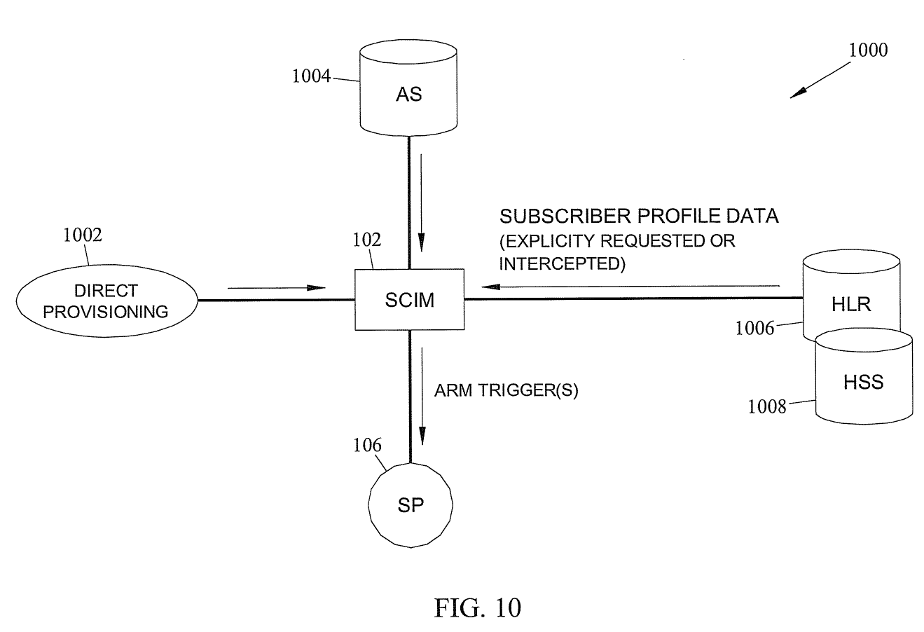

FIG. 10 is a block diagram illustrating an exemplary system for providing service interaction and mediation in a communications network in accordance with another embodiment of the subject matter described herein. FIG. 10 illustrates the various types of information that may be processed by an ESCIM that is performing a trigger management function.

In the embodiment illustrated in FIG. 10, system 1000 includes an ESCIM 102 and service client 106 as described in reference to FIG. 1. ESCIM 102 performs a trigger management function. In one embodiment, performing trigger management means that ESCIM 102 acts as an intermediary between a service client 106 and various network entities that may request subscription to (i.e., notification of) triggers or other events that may occur at the service client 106. For simplicity, all events to which a network entity may desire to be subscribed are referred collectively as “triggers”. In the embodiment illustrated in FIG. 10, system 1000 includes a provisioning entity (PROV) 1002, an application server (AS) 1004, a home location register (HLR) 1006, and a home subscriber service (HSS) 1008. As will be described in detail below, some entities may directly request subscription to a particular trigger; this is referred to as an “explicit request”. Some entities may make a request or issue a command that does not directly request subscription to a trigger, but the fulfillment of which requires subscription to a trigger; this is referred to as an “implicit request”.

For example, AS 1004 may send an explicit request such as the arm term trigger messages 2 and 4 as shown in FIG. 9A. In this scenario, AS 1004 may specify one or more triggers of which it wants to be notified. In an example of an implicit request, PROV 1002 may send a provisioning request or command to ESCIM 102. Similarly, HLR 1006 may send an SS7 MAP “Insert subscriber data” message to service client 106; ESCIM 102 may intercept this message on its way to service client 106. Such a provisioning request may identify a new subscriber to be added or an existing subscriber to which a change of service may apply.

Rather than listing the particular triggers that should be subscribed to, a provisioning message may describe a particular service, or a particular class of customers, where the class of customers implies a particular set of services. This information about a subscriber, including what services the subscriber is eligible to receive, is hereinafter referred to as the subscriber's “profile”. In this case, ESCIM 102 may determine, based on a subscriber profile information, the list of triggers for which the subscriber should receive notification from the service client 106.

In another example of an implicit request, ESCIM 102 may receive profile data from network entities that maintain such subscriber information, such as from HLR 1006 in a 2^{nd} generation (2G) network or from HSS 1008 in a 3^{rd} generation (3G) network. This profile information may be sent to ESCIM 102 in response to a query from ESCIM 102 or it may be intercepted by ESCIM 102. ESCIM 102 may use this profile information to determine what subscription requests should be sent to service client 106 on behalf of the subscriber, or, if you prefer, on behalf of the application servers 1004 that provide services to the subscriber.

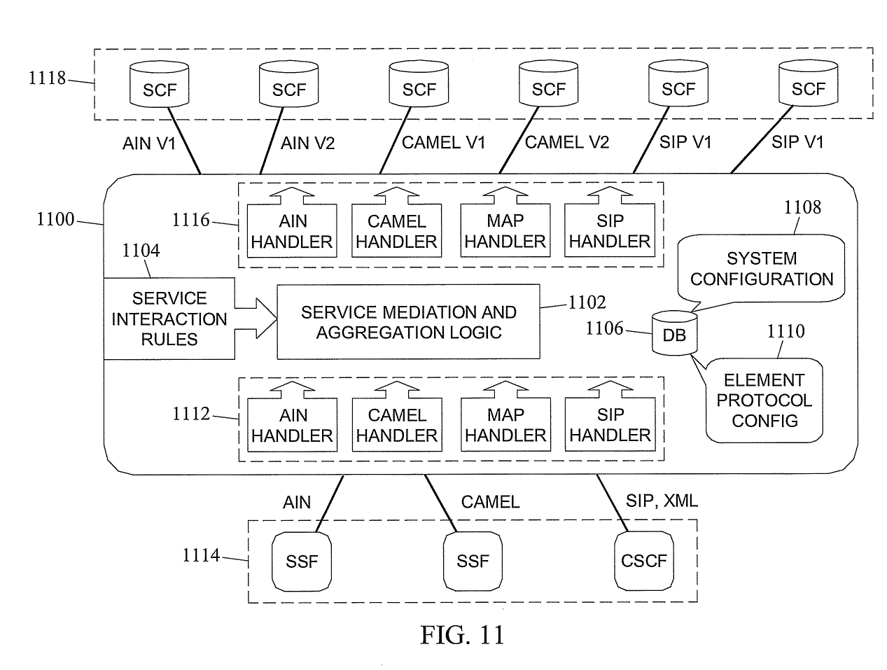

FIG. 11 is a block diagram illustrating an exemplary service capability interaction manager (ESCIM) having an extendable architecture in accordance with another embodiment of the subject matter described herein.

In the embodiment illustrated in FIG. 11, ESCIM 1100 includes a service mediation and aggregation logic 1102 module. The operation of service mediation and aggregation logic 1102 may be based on service interaction rules 1104. ESCIM 1100 may include a database DB 1106 for storing system configuration information 1108, element protocol configuration information, 1110, or other information useful or necessary to the function of ESCIM 1100.

In one embodiment, ESCIM 1100 is adapted to operate with modular functional units that may be provisioned on ESCIM 1100 as necessary. For example, ESCIM 1100 may include input protocol handlers 1112 for converting signaling messages received from a variety of service clients 1114 from the protocol used by a service client into the protocol used by ESCIM 1100. Similarly, ESCIM 1100 may include output protocol handlers 1116 for converting signaling messages from the internal protocol used by ESCIM 1100 into the protocol used by a variety of application servers 1118.

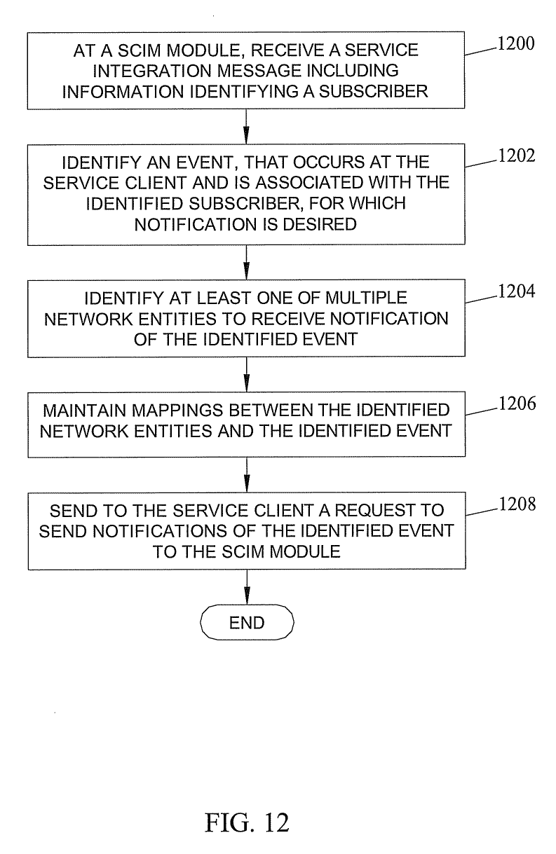

FIG. 12 is a flow chart illustrating an exemplary process for providing service interaction and mediation in a communication network in accordance with another embodiment of the subject matter described herein.

At block 1200, a service integration message including information identifying a subscriber is received at a SCIM module. For example, referring to FIG. 10, ESCIM 102 may receive a message from PROV 1002, AS 1004, HLR 1006, or HSS 1008.

At block 1202, an event that occurs at the service client and is associated with the identified subscriber (here, subscriber X) and for which notification is desired, is identified, and at block 1204, one or more network entities are identified as candidates to receive notification of the identified event. For example, AS 1004 may want to be notified of any initial detection point (IDP) triggers associated with subscriber X.

At block 1206, mapping between the identified network entities and the identified event is maintained. For example, ESCIM 102 may maintain this mapping in a database for that purpose.

At block 1208, a request to send notifications of the identified event to the SCIM module is sent to the service client. For example, ESCIM 102 may send an “arm term trigger” message to service client 106, requesting that service client 106 send notification of certain events associated with subscriber X.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A system for providing service interaction and mediation in a communications network, the system comprising:
a communications interface for receiving a client-to-SCIM message from a service client; and
a service capability interaction manager (SCIM) module for providing service interaction between the service client and a plurality of application servers providing different types of services, wherein providing the service interaction includes:
receiving, from the communications interface, the client-to-SCIM service interaction message, and, in response to receiving the client-to-SCIM message, generating a plurality of SCIM-to-server messages and sending the SCIM-to-server messages to at least some of the plurality of application servers; and
receiving a plurality of server-to-SCIM service interaction messages from at least some of the plurality of application servers that received the SCIM-to-server messages, and, in response to receiving the server-to-SCIM messages, generating a SCIM-to-client message containing an aggregation of at least a portion of data from at least some of the server-to-SCIM messages, and sending the SCIM-to-client message containing the aggregation to the service client via the communications interface.

2. The system of claim 1 wherein the service capability interaction manager module is configured to generate the SCIM-to-server messages based on an analysis of a component of the client-to-SCIM message.

3. The system of claim 1 wherein the communications interface and the service capability interaction manager module are co-located with a network signaling point.

4. The system of claim 1 wherein the SCIM module is configured to convert received client-to-SCIM messages between at least one of:
a SIP protocol and a non-SIP protocol;
a CAMEL protocol and an IMS protocol; and
one version of a protocol and another version of a protocol; and
an internal protocol used internally by the SCIM module and an external protocol, used by a network entity other than the SCIM module, that is different from the internal protocol.

5. The system of claim 1 wherein generating a SCIM-to-client message containing an aggregation of at least a portion of data from at least some of the server-to-SCIM messages includes suppressing duplicate SCIM-to-client messages to the service client.

6. The system of claim 1 wherein generating a SCIM-to-client message containing an aggregation of at least a portion of data from at least some of the server-to-SCIM messages includes consolidating information contained in a plurality of SCIM-to-client messages into a single SCIM-to-client message to the service client.

7. The system of claim 1 wherein the SCIM module is configured to generate at least one of call detail records (CDRs) for calls associated with messages processed by the SCIM module and transaction data records (TDRs) for transactions associated with messages processed by the SCIM module.

8. The system of claim 1 wherein the service capability interaction manager module is configured to manage message subscription and notification in a communications network, wherein managing message subscription and notification includes:
receiving, from at least some of the plurality of application servers, requests to be notified of specified events, and in response to receiving the requests, creating an aggregation of the notification requests and sending a message containing the aggregation to the service client;
maintaining mappings between the application servers and the specified events; and
receiving notification of an event, and, in response, identifying at least one application server subscribed to receive notification of the event using the mappings and notifying the at least one identified application server of the event.

9. The system of claim 8 wherein creating an aggregation of the notification requests and sending a message containing the aggregation to the service client includes forwarding to the service client a first request to be notified of a specific event and not forwarding to the service client subsequent requests to be notified of the specific event.

10. The system of claim 8 wherein creating an aggregation of the notification requests and sending a message containing the aggregation to the service client includes consolidating information contained in the notification requests into a single notification request and sending the single notification request to the service client.

11. The system of claim 8 wherein notifying the at least one identified application server of the event includes notifying a plurality of application servers of the event.

12. The system of claim 8 wherein notifying the at least one identified application server of the event includes: notifying one of the plurality of application servers of the event; receiving, from the one application server, a response to the notification; determining, based on the response to the notification, whether to notify another of the plurality of application servers of the event, and, based on that determination, notifying another of the plurality of application servers of the event.

13. A system for providing rules-based service interaction and mediation in a communications network, the system comprising:
a service interaction and mediation rules database for storing the service interaction and mediation rules for providing service interaction and mediation; and
a service capability interaction manager (SCIM) module for providing, using service interaction and mediation rules stored in the service interaction and mediation rules database, service interaction and mediation between a service client and a plurality of application servers providing different types of services, wherein the service capability interaction manager module is configured to receive at least one incoming service interaction message; identify, using a component of one of the incoming messages, a service interaction and mediation rule; generate, using the identified rule, at least one outgoing service interaction message; and send the at least one outgoing message.

14. The system of claim 13 wherein receiving the at least one incoming message includes receiving a client-to-SCIM message from a service client, wherein generating the at least one outgoing message includes generating a plurality of SCIM-to-server messages, and wherein sending the at least one outgoing message includes sending the SCIM-to-server messages to at least some of the plurality of application servers.

15. The system of claim 13 wherein receiving the at least one incoming message includes receiving a plurality of server-to-SCIM messages from at least some of the plurality of application servers, wherein generating the at least one outgoing message includes generating a SCIM-to-client message containing an aggregation of at least a portion of data from at least some of the server-to-SCIM messages, and wherein sending the at least one outgoing message includes sending the SCIM-to-client message containing the aggregation to a service client.

16. The system of claim 15 wherein generating a SCIM-to-client message containing an aggregation of at least a portion of data from at least some of the server-to-SCIM messages includes suppressing duplicate SCIM-to-client messages.

17. The system of claim 15 wherein generating a SCIM-to-client message containing an aggregation of at least a portion of data from at least some of the server-to-SCIM messages includes consolidating information contained in a plurality of SCIM-to-client messages into a single SCIM-to-client message.

18. The system of claim 1 wherein the SCIM module is configured to generate at least one of call detail records (CDRs) for calls associated with messages processed by the SCIM module and transaction data records (TDRs) for transactions associated with messages processed by the SCIM module.

19. The system of claim 13 comprising an interface for remotely updating the service interaction and mediation rules database.

20. The system of claim 13 wherein the component of an incoming message includes a service key parameter.

21. The system of claim 13 wherein at least one of the service capability interaction manager module and the service interaction and mediation rules database is co-located with a network signaling point.

22. The system of claim 13 wherein the SCIM module is configured to manage message subscription and notification in a communications network, wherein managing message subscription and notification includes:
receiving, from at least some of the plurality of application servers, requests to be notified of specified events, and in response to receiving the requests, creating an aggregation of the notification requests and sending a message containing the aggregation to the service client;
maintaining mappings between the application servers and the specified events; and
receiving notification of an event, and, in response, identifying at least one application server subscribed to receive notification of the event using the mappings and notifying the at least one identified application server of the event.

23. The system of claim 22 wherein notifying the at least one identified application server of the event includes notifying a plurality of application servers of the event.

24. The system of claim 22 wherein notifying the at least one identified application server of the event includes: notifying one of the plurality of application servers of the event; receiving, from the one application server, a response to the notification; determining, based on the response to the notification, whether to notify another of the plurality of application servers of the event, and, based on that determination, notifying another of the plurality of application servers of the event.

25. The system of claim 22 wherein the SCIM module is configured to, in response to receiving notification of an event, send a SCIM-to-server message to one of the plurality of applications servers, wherein the one application server is not identified as subscribed to receive notification of the event.

26. A system for providing service interaction and mediation in a communications network, the system comprising:
a communications interface for receiving a service interaction message including information identifying a subscriber; and
a service capability interaction manager (SCIM) module for providing service interaction and mediation between a service client and a plurality of network entities, wherein providing the service interaction includes:
identifying an event, occurring at the service client and associated with the identified subscriber, for which notification is desired;
identifying at least one of the plurality of network entities for receiving notification of the identified event;
maintaining mappings between the identified network entities and the identified event; and
sending, to the service client, a request to send notification of the identified event to the SCIM module.

27. The system of claim 26 wherein the SCIM module is configured to determine, prior to sending to the service client a request to send notifications of the identified event to the SCIM module, if the service client is configured to send to the SCIM module notification of the identified event, and, upon a determination that the service client is not configured to send to the SCIM module notification of the identified event, send to the service client the request to send notifications of the event to the SCIM module.

28. The system of claim 26 wherein the SCIM module is configured to receive, from the service client, notification of an event, and, in response to receiving the notification, identify, using the mappings, at least one network entity subscribed to receive notification of the event and notify the at least one identified network entity of the event.

29. The system of claim 26 wherein the received service interaction message includes at least one of:
identification of an event for which notification is desired;
profile information for the subscriber;
a service to which the subscriber is subscribed; and
a network entity to which notification is to be sent.

30. The system of claim 29 wherein the event for which notification is required comprises a service trigger.

31. The system of claim 26 wherein the SCIM module is configured to identify at least one of the event for which notification is desired and the at least one of the plurality of network entities for receiving notification of the identified event based on at least one of:
information contained in the service interaction message;
information included in the identified subscriber's profile; and
information returned from a query for information associated with the identified subscriber.

32. The system of claim 31 wherein the information returned from a query for information associated with the identified subscriber includes information returned from a query to at least one of a home location register (HLR), a visitor location register (VLR), and a home subscriber server (HSS).

33. The system of claim 26 wherein the SCIM module is configured to maintain mappings between the identified network entities and the identified event using a database for associating subscribers, events, and network entities.

34. The system of claim 33 where the database is one of co-located with the SCIM module and not co-located with the SCIM module.

35. The system of claim 26 wherein the service interaction message is received from one of an application server (AS), a service control point (SCP), a home location register (HLR), a visitor location register (VLR), a home subscriber server (HSS), and a network entity for providing provisioning information.

36. The system of claim 26 wherein the service interaction message is received in response to a prior request, sent from the SCIM module, for information associated with the identified subscriber.

37. The system of claim 26 wherein the service interaction message is sent to the SCIM module from a message source in response to a provisioning operation occurring at the message source.

38. A service capability interaction manager (SCIM) having an extendable architecture, the SCIM comprising:
a database for storing system configuration information and element protocol configuration information;
a service interaction rules module for storing service interaction and mediation rules;
a service mediation and aggregation logic module for providing service mediation and aggregation in a communications network based on the service interaction and mediation rules stored by the service interaction rules module and the system configuration information stored in the database; and
a plurality of protocol handlers for performing protocol mediation and conversion between a protocol used by the service mediation and aggregation logic and protocols used by the plurality of network entities, based on the element protocol configuration information stored in the database.

39. A method for providing service interaction and mediation in a communications network, the method comprising:
at a service capability interaction manager (SCIM) module for performing service interaction and mediation between a service client and a plurality of application servers providing different services:
receiving, from the service client, a client-to-SCIM service interaction message, and, in response to receiving the client-to-SCIM message, generating a plurality of SCIM-to-server messages and sending the SCIM-to-server messages to at least some of the plurality of application servers; and
receiving a plurality of server-to-SCIM service interaction messages from at least some of the plurality of application servers that received the SCIM-to-server messages, and, in response to receiving the server-to-SCIM messages, generating a SCIM-to-client message containing an aggregation of at least a portion of data from at least some of the server-to-SCIM messages, and sending the SCIM-to-client message containing the aggregation to the service client.

40. The method of claim 39 wherein generating the SCIM-to-server messages includes generating the SCIM-to-server messages based on analysis of a component of the client-to-SCIM message.

41. The method of claim 39 wherein the SCIM module is co-located with a network signaling point.

42. The method of claim 39 wherein generating the SCIM-to-server messages in response to the client-to-SCIM message includes converting between one of:
a SIP protocol and a non-SIP protocol;
a CAMEL protocol and an IMS protocol; and
one version of a CAMEL protocol and another version of a CAMEL protocol.

43. The method of claim 39 wherein generating a SCIM-to-client message containing an aggregation of at least a portion of data from at least some of the server-to-SCIM messages includes suppressing duplicate SCIM-to-client messages.

44. The method of claim 39 wherein generating a SCIM-to-client message containing an aggregation of at least a portion of data from at least some of the server-to-SCIM messages includes consolidating information contained in a plurality of SCIM-to-client messages into a single SCIM-to-client message.

45. The method of claim 39 wherein the SCIM module is configured to generate at least one of call detail records (CDRs) for calls associated with messages processed by the SCIM module and transaction data records (TDRs) for transactions associated with messages processed by the SCIM module.

46. The method of claim 39 comprising managing, by the SCIM module, message subscription and notification in a communications network, wherein managing message subscription and notification includes:
receiving, from at least some of the plurality of application servers, requests to be notified of specified events, and in response to receiving the requests, creating an aggregation of the notification requests and sending a message containing the aggregation to the service client;
maintaining mappings between the application servers and the specified events; and
receiving notification of an event, and, in response to receiving the notification, identifying at least one application server subscribed to receive notification of the event using the mappings and notifying the at least one identified application server of the event.

47. The method of claim 46 wherein creating an aggregation of the notification requests and sending a message containing the aggregation to the service client includes forwarding to the service client a first request to be notified of a specific event and not forwarding to the service client subsequent requests to be notified of the specific event.

48. The method of claim 46 wherein creating an aggregation of the notification requests and sending a message containing the aggregation to the service client includes consolidating information contained in the notification requests into a single notification request and sending the single notification request.

49. The method of claim 46 wherein notifying the at least one identified application server of the event includes notifying a plurality of application servers of the event.

50. The method of claim 46 wherein notifying the at least one identified application server of the event includes: notifying one of the plurality of application servers of the event; receiving, from the one application server, a response to the notification; determining, based on the response to the notification, whether to notify another of the plurality of application servers of the event, and, based on that determination, notifying another of the plurality of application servers of the event.

51. A method for providing rules-based service interaction and mediation in a communications network, the method comprising: at a service capability interaction manager (SCIM) module for service interaction and mediation between a service client and a plurality of application servers providing different services:
receiving at least one incoming service interaction message;
identifying, using a component of one of the incoming messages, a service interaction and mediation rule in a service interaction and mediation rules database operatively associated with the service capability interaction manager module and for storing service interaction and mediation rules for performing service interaction and mediation;
generating, using the identified rule, at least one outgoing service interaction message; and
sending the at least one outgoing message.

52. The method of claim 51 wherein receiving the at least one incoming message includes receiving a client-to-SCIM message from the service client, wherein generating the at least one outgoing messages includes generating a plurality of SCIM-to-server messages, and wherein sending the at least one outgoing message includes sending the SCIM-to-server messages to at least some of the plurality of application servers.

53. The method of claim 51 wherein receiving the at least one incoming message includes receiving a plurality of server-to-SCIM messages from at least some of the plurality of application servers, wherein generating the at least one outgoing message includes generating a SCIM-to-client message containing an aggregation of at least a portion of data from at least some of the server-to-SCIM messages, and wherein sending the at least one outgoing message includes sending the SCIM-to-client message containing the aggregation to a service client.

54. The method of claim 53 wherein generating a SCIM-to-client message containing an aggregation of at least a portion of data from at least some of the server-to-SCIM messages includes suppressing duplicate SCIM-to-client messages.

55. The method of claim 53 wherein generating a SCIM-to-client message containing an aggregation of at least a portion of data from at least some of the server-to-SCIM messages includes consolidating information contained in a plurality of SCIM-to-client messages into a single SCIM-to-client message.

56. The method of claim 51 wherein the SCIM module is configured to generate at least one of call detail records (CDRs) for calls associated with messages processed by the SCIM module and transaction data records (TDRs) for transactions associated with messages processed by the SCIM module.

57. The method of claim 51 wherein the component of one of the incoming messages includes a service key parameter.

58. The method of claim 51 wherein the service capability interaction manager module is co-located with a network signaling point.

59. The method of claim 51 comprising managing, by the service capability interaction manager module, message subscription and notification in a communications network, wherein managing message subscription and notification includes:
receiving, from at least some of the plurality of application servers, requests to be notified of specified events, and in response to receiving the requests, creating an aggregation of the notification requests and sending a message containing the aggregation to the service client;
maintaining mappings between the application servers and the specified events; and
receiving notification of an event, and, in response, identifying at least one application server subscribed to receive notification of the event using the mappings and notifying the at least one identified application server of the event.

60. The method of claim 59 wherein notifying the at least one identified application server of the event includes notifying a plurality of application servers of the event.

61. The method of claim 59 wherein notifying the at least one identified application server of the event includes: notifying one of the plurality of application servers of the event; receiving, from the one application server, a response to the notification; determining, based on the response to the notification, whether to notify another of the plurality of application servers of the event, and, based on that determination, notifying another of the plurality of application servers of the event.

62. The system of claim 59 wherein the SCIM module is configured to, in response to receiving notification of an event, send a SCIM-to-server message to one of the plurality of applications servers, wherein the one application server is not identified as subscribed to receive notification of the event.

63. A method for providing service interaction and mediation in a communications network, the method comprising:
at a service capability interaction manager (SCIM) module for performing service interaction and mediation between a service client and a plurality of network entities:
receiving a service interaction message including information identifying a subscriber;
identifying an event, that occurs at the service client and is associated with the identified subscriber, for which notification is desired;
identifying at least one of the plurality of network entities to receive notification of the identified event;
maintaining mappings between the identified network entities and the identified event; and
sending, to the service client, a request to send notifications of the identified event to the SCIM module.

64. The method of claim 63 wherein sending, to the service client, a request to send notifications of the identified event to the SCIM module includes determining if the service client is configured to send to the SCIM module notification of the identified event, and, upon a determination that the service client is not configured to send to the SCIM module notification of the identified event, sending to the service client the request to send notifications of the event to the SCIM module.

65. The method of claim 63 comprising receiving, from the service client, notification of an event, and, in response to receiving the notification, identifying, using the mappings, at least one network entity subscribed to receive notification of the event and notifying the at least one identified network entity of the event.

66. The method of claim 63 wherein receiving the service interaction message includes receiving a service interaction message including at least one of:
an event for which notification is desired;
profile information for the subscriber;
a service to which the subscriber is subscribed; and
a network entity to which notification is to be sent.

67. The method of claim 63 wherein identifying an event for which notification is required comprises identifying a service trigger.

68. The method of claim 63 wherein identifying an event for which notification is desired and identifying at least one of the plurality of network entities for receiving notification of the identified event is based on at least one of:
information contained in the service interaction message;
information included in the identified subscriber's profile; and
information returned from a query for information associated with the identified subscriber.

69. The method of claim 67 wherein the information returned from a query for information associated with the identified subscriber includes information returned from a query to at least one of a home location register (HLR), a visitor location register (VLR), and a home subscriber server (HSS).

70. The method of claim 63 wherein maintaining mappings between the identified network entities and the identified event includes maintaining a database for associating subscribers, events, and network entities.

71. The method of claim 70 where maintaining a database includes at least one of maintaining a database that is co-located with the SCIM module and maintaining a database that is not co-located with the SCIM module.

72. The method of claim 63 wherein receiving the service interaction message comprises receiving the service interaction message from one of an application server (AS), a service control point (SCP), a home location register (HLR), a visitor location register (VLR), a home subscriber server (HSS), and a network entity for providing provisioning information.

73. The method of claim 63 wherein the service interaction message is received in response to a prior request, sent from the SCIM module, for information associated with the identified subscriber.

74. The method of claim 63 wherein the service interaction message is sent to the SCIM module from a message source in response to a provisioning operation occurring at the message source.

75. A computer readable medium having stored thereon computer-executable instructions that when executed by the processor of a computer perform steps comprising:
at a service capability interaction manager (SCIM) module for performing service interaction and mediation between a service client and a plurality of application servers providing different services:
receiving, from the service client, a client-to-SCIM service interaction message, and, in response to receiving the client-to-SCIM message, generating a plurality of SCIM-to-server messages and sending the SCIM-to-server messages to at least some of the plurality of application servers; and
receiving a plurality of server-to-SCIM service interaction messages from at least some of the plurality of application servers that received the SCIM-to-server messages, and, in response to receiving the server-to-SCIM messages, generating a SCIM-to-client message containing an aggregation of at least a portion of data from at least some of the server-to-SCIM messages, and sending the SCIM-to-client message containing the aggregation to the service client.

76. A computer readable medium having stored thereon computer-executable instructions that when executed by the processor of a computer perform steps comprising:
at a service capability interaction manager (SCIM) module for performing service interaction and mediation between a service client and a plurality of application servers providing different services:
receiving at least one incoming service interaction message;
identifying, using a component of one of the incoming messages, a service interaction and mediation rule in a service interaction and mediation rules database operatively associated with the service capability interaction manager module and for storing service interaction and mediation rules for performing service interaction and mediation;
generating, using the identified rule, at least one outgoing service interaction message; and
sending the at least one outgoing message.

77. A computer readable medium having stored thereon computer-executable instructions that when executed by the processor of a computer perform steps comprising:
receiving a service interaction message including information identifying a subscriber;
identifying an event, occurring at the service client and associated with the identified subscriber, for which notification is desired;
identifying at least one of the plurality of network entities for receiving notification of the identified event;
maintaining mappings between the identified network entities and the identified event; and
determining if the service client is configured to send notification of the identified event, and, if not, sending to the service client a request to be notified of the identified event.
